(19) United States
(12) Patent Application Publication
(10) Pub. No.: US 2026/0289613 A1
(43) Pub. Date: Sep. 24, 2026

(54) SYSTEM

(71) Applicant: SoftBank Group Corp., Tokyo (JP)

(72) Inventor: Masanori KATSUBE, Tokyo (JP)

(73) Assignee: SoftBank Group Corp., Tokyo (JP)

(21) Appl. No.: 19/564,747

(22) Filed: Mar. 12, 2026

(30) Foreign Application Priority Data
Mar. 19, 2025 (JP) 2025-044506

(51) Int. Cl. G06Q 30/0241; G06F 16/3329

(52) U.S. Cl. CPC G06Q 30/0276; G06F 16/33295

(57) ABSTRACT

A system includes a processor that is configured to receive product characteristics and user attributes as input, generate a prompt sentence that instructs a generative AI model to generate an asset sentence based on the received input information, automatically generate the asset sentence based on the prompt sentence by using the generative AI model, apply the generated asset sentence to an advertisement, and cause the advertisement to be displayed.

### CROSS-REFERENCE TO RELATED APPLICATION

This application is based on and claims priority under 35 USC 119 from Japanese Patent Application No. 2025-044506 filed on Mar. 19, 2025, the disclosure of which is incorporated by reference herein.

### BACKGROUND

### Technical Field

The present disclosure relates to a system.

Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional online advertising systems often rely on static or manually created ad texts that do not sufficiently reflect detailed product characteristics or individual user attributes. As a result, advertisements are frequently generic, fail to attract user interest effectively, and do not adapt in a timely manner to changes in user behavior, such as recent search activities or browsing history. Although some systems support limited personalization, they typically require manual rule setting or template design, which increases operational cost and makes fine-grained, real-time optimization difficult. Furthermore, existing approaches do not fully utilize generative AI models in a structured way, for example by generating prompts from product and user information and then automatically generating asset sentences suitable for responsive advertisements. Accordingly, there is a need for a system that can (i) automatically generate ad asset sentences based on product characteristics and user attributes by using a generative AI model, (ii) apply the generated asset sentences to advertisements, and (iii) further optimize and update the asset sentences in response to user behavior history and real-time changes in user context, thereby improving the relevance and effectiveness of online advertisements.

### SUMMARY

In order to solve the above problem, a system is provided that comprises a processor, wherein the processor is configured to receive product characteristics and user attributes as input, generate a prompt sentence that instructs a generative AI model to generate an asset sentence based on the received input information, automatically generate the asset sentence based on the prompt sentence by using the generative AI model, apply the generated asset sentence to an advertisement, and cause the advertisement to be displayed. In one aspect, the processor is further configured to optimize the asset sentence based on a behavior history of a user, such as search history, browsing history, or interaction history with advertisements, so that the content of the asset sentence more closely reflects the user's current interests and intentions. In another aspect, the processor is further configured to update the asset sentence in real time in accordance with at least one of an attribute of the user and a behavior of the user, thereby enabling dynamic adaptation of the advertisement text to changes in user attributes or user actions occurring during ongoing sessions. By combining prompt generation, generative AI-based asset sentence creation, behavior-based optimization, and real-time updating within a single system, the invention enables efficient and highly personalized responsive advertisements without extensive manual configuration.

The term “processor” refers to any hardware, firmware, or combination of hardware and software components that executes instructions, including but not limited to a central processing unit (CPU), graphics processing unit (GPU), microcontroller, or distributed processing resources in a server or cloud environment.

The term “product characteristics” refers to information describing an item or service to be advertised, including but not limited to a product category, price range, target customer segment, product name, specifications, features, and other attributes used for ad content generation.

The term “user attributes” refers to information describing a user to whom an advertisement is to be presented, including but not limited to age, gender, hobbies, interests, demographic information, preferences, and purchase history.

The term “prompt sentence” refers to a text string or other machine-interpretable instruction generated by the processor and provided as input to a generative AI model, the content of which directs the generative AI model to generate an asset sentence based on product characteristics and user attributes.

The term “generative AI model” refers to a machine learning model, such as a large language model or other generative model, that is configured to generate natural language text or similar content in response to a given input, including but not limited to a prompt sentence.

The term “asset sentence” refers to a unit of text, including one or more sentences or phrases, that is generated by the generative AI model and is intended to be used as an advertisement text component, such as a headline, description, or body text of an advertisement.

The term “automatically generate” refers to performing generation processing by the system without requiring manual text creation by a human operator for each individual advertisement, based on input data and predefined logic or models.

The term “advertisement” refers to any digital ad content presented to a user, including but not limited to banner ads, responsive display ads, search ads, in-app ads, or other promotional content that includes at least one asset sentence.

The term “apply the generated asset sentence to an advertisement” refers to inserting, embedding, or associating the generated asset sentence with an advertisement format or template so that the asset sentence becomes part of the displayable ad content.

The term “cause the advertisement to be displayed” refers to controlling or instructing a display device or client terminal to present the advertisement, including the asset sentence, on a screen or graphical user interface visible to the user.

The term “behavior history of a user” refers to recorded data representing past actions of the user, including but not limited to search queries, page views, click events, purchase actions, and other interactions with content or advertisements.

The term “optimize the asset sentence” refers to modifying, selecting, or regenerating an asset sentence so as to improve its relevance, effectiveness, or personalization, based at least in part on the behavior history of the user.

The term “update the asset sentence in real time” refers to changing or regenerating the asset sentence during an ongoing user session or within a short time after a change in user attributes or behavior, so that the displayed advertisement reflects the latest available user information.

The term “attribute of the user” refers to any static or semi-static characteristic of the user, including but not limited to demographic information, profile settings, declared preferences, and other user-related data distinct from real-time behavior events.

The term “behavior of the user” refers to any action performed by the user that can be detected by the system, including but not limited to entering search queries, navigating between pages, clicking links or ads, viewing content, and making purchases.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

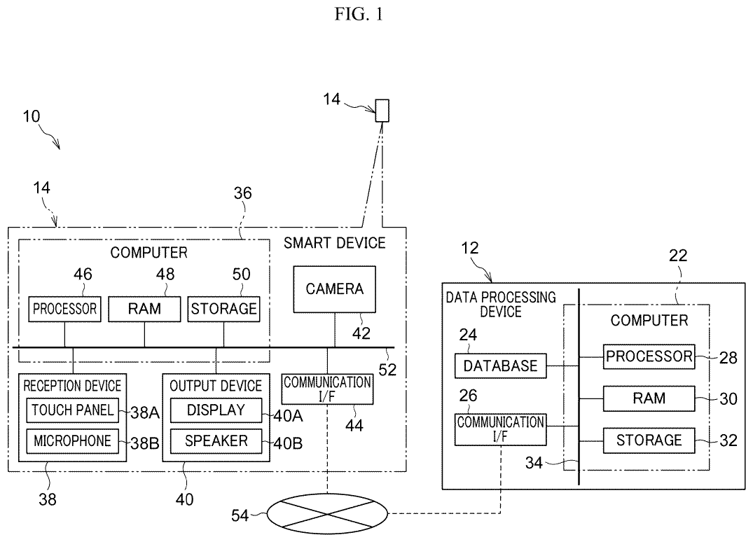

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

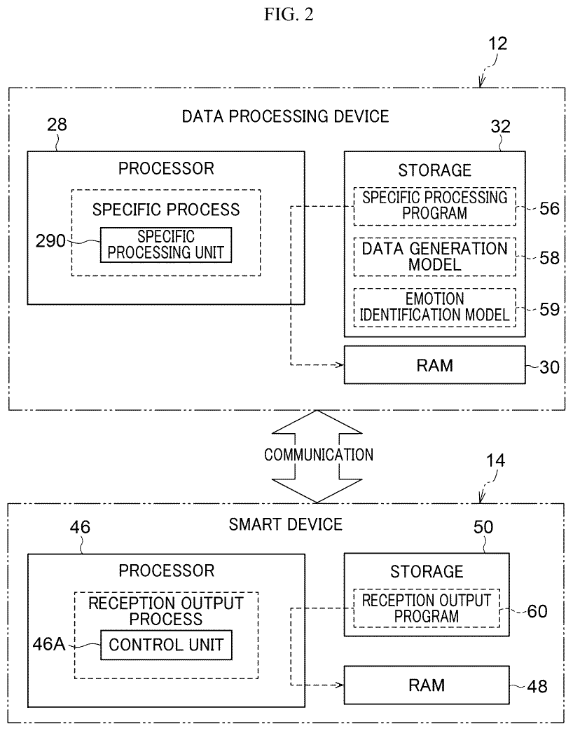

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented advertising systems typically rely on static templates or manually authored text, which are selected or slightly varied based on user attributes and basic targeting rules. In such systems, a processor generally performs only simple matching or keyword substitution, while the substantive content of the advertisement is fixed in advance. As a result, these systems are limited in their ability to adapt advertisement text to fine-grained combinations of merchandise characteristics and user attributes, such as detailed behavioral histories, current contexts, and nuanced preference patterns. This limitation leads to a mismatch between the advertising content and the user's actual interests, thereby reducing click-through rates, conversion rates, and overall campaign performance.

Further, when generative AI models are naively integrated into advertisement systems, the computer system often acts merely as a pass-through interface: a user manually crafts a prompt sentence, submits it to an external generative AI service, and receives unstructured output. In such architectures, the processor does not systematically transform structured input data into optimized prompt sentences, nor does it apply automatic post-processing and validation on the generated asset sentences. Consequently, the generated advertisement text may be inconsistent in style, length, and policy compliance, and may require extensive manual review and editing. This increases computational overhead related to repeated input/output operations, causes latency in generating usable advertisement text, and reduces the efficiency and scalability of the overall computer system. In addition, known systems do not fully leverage the user's behavior history as machine-processable feature information within the prompt generation pipeline. Behavior logs are often stored as raw records or coarse segments and are not automatically summarized into compact, semantically meaningful features that can guide generative AI models. This underutilization of behavior data diminishes the capability of the computer system to compute highly personalized advertisement text, and fails to exploit the representational power of the underlying hardware and software resources. Moreover, many existing implementations update advertisement text in batch mode or at long intervals. Even when real-time behavioral signals are available from terminals, the system architecture and processing logic often do not support continuous regeneration of prompt sentences and asset sentences based on streaming updates. This causes the advertisement content displayed on user devices to lag behind the user's most recent actions, and prevents the computer system from achieving dynamic, responsive personalization in real time.

Accordingly, there is a need for an improved computer-implemented system and server-side processing technique that: (i) transforms structured merchandise and user information, including behavior history, into optimized prompt sentences for a generative AI model; (ii) automatically evaluates and post-processes generated asset sentences under predetermined constraints; and (iii) updates advertisement configuration information in real time based on incoming user signals. Such a system should enhance the technical functioning of the computer by orchestrating data normalization, prompt construction, AI interaction, and validation in an integrated, automated pipeline, thereby reducing manual intervention, improving processing efficiency, and enabling more effective and adaptive advertisement presentation.

The specific processing by the specific processing unit 290 of the data processing device 12 in Example 1 is realized by the following means.

The present invention provides a server comprising a processor configured to receive, from a terminal, item information relating to a merchandise and user information relating to a user; to store the received item information and user information as structured information in a storage device and perform normalization and preprocessing on the structured information so that heterogeneous inputs are transformed into a unified, machine-interpretable representation; to generate, based on the preprocessed structured information, a prompt sentence suitable for a generative AI model by assembling an instruction sentence for input to a language generation apparatus using one or more templates, thereby algorithmically transforming the structured information into a natural-language control instruction; to transmit, via a communication interface, the generated prompt sentence to the language generation apparatus and acquire, from the language generation apparatus, an asset sentence which is advertisement text corresponding to the prompt sentence; to determine, by executing validation logic, whether the acquired asset sentence satisfies one or more constraints including a length constraint, an expression constraint, and an inappropriate-expression constraint, and in response to the asset sentence not satisfying at least one of the constraints, to perform at least one of re-requesting generation from the language generation apparatus and executing an automatic correction process on the asset sentence; to associate the asset sentence with advertisement configuration information and store the associated information as advertisement information for advertisement distribution; to aggregate history information based on user behavior history as part of the item information and the user information, generate feature information by summarizing the history information, and incorporate the feature information into the prompt sentence so as to optimize the asset sentence; and to sequentially receive, from the terminal, updated user attribute information and user behavior information, regenerate the prompt sentence and the asset sentence based on the updated information, and update the advertisement configuration information in real time so that advertisements including the updated asset sentence are distributed and displayed on one or more terminals. This enables the computer system to technically improve the generation and delivery of personalized advertisements by converting structured merchandise and user data into optimized prompt sentences, by automatically validating and correcting AI-generated advertisement text, and by dynamically updating advertisement configuration information in response to real-time user signals, thereby reducing manual workload, lowering latency, and enhancing the overall efficiency and responsiveness of the advertisement generation and presentation pipeline.

The term “processor” refers to a hardware execution unit, such as a central processing unit or a processing circuit, that executes program instructions to perform the functions described in the present specification and claims.

The term “terminal” refers to an information processing device, such as a client computing device, a mobile computing device, or a display device, operated by a user and configured to transmit information to and receive information from a server.

The term “item information” refers to information relating to a merchandise or service, including but not limited to category information, price information, target segment information, and other attribute information associated with the merchandise or service.

The term “user information” refers to information relating to a user, including but not limited to demographic information, preference information, and behavior information such as a behavior history of the user.

The term “structured information” refers to information that has been organized into a predefined data format or schema, such as key-value pairs, records, or other machine-interpretable structures, to enable systematic processing by a processor.

The term “normalization” refers to processing in which heterogeneous or inconsistent input data is converted into a unified representation, including but not limited to trimming, standardizing formats, mapping synonyms to canonical labels, and otherwise harmonizing values.

The term “preprocessing” refers to one or more operations performed on input information prior to prompt generation, including but not limited to filtering, cleaning, converting, aggregating, or transforming the information into a form suitable for subsequent processing by a generative AI model.

The term “prompt sentence” refers to a natural-language instruction sentence or set of sentences generated from structured information and configured to be input to a generative AI model or a language generation apparatus to control generation of an output text.

The term “template” refers to a predefined pattern or format including placeholders, which is used by a processor to assemble a prompt sentence by inserting structured information into designated positions.

The term “generative AI model” refers to a machine learning model configured to generate natural-language text based on an input prompt, including but not limited to a language model implemented on a language generation apparatus.

The term “language generation apparatus” refers to a computing apparatus, which may be remote from a server, that executes a generative AI model and generates an output text in response to a prompt sentence input.

The term “asset sentence” refers to a generated text segment in natural language that is obtained from a language generation apparatus in response to a prompt sentence and that is configured to function as advertisement text.

The term “advertisement configuration information” refers to information defining how an advertisement is to be constructed, targeted, and presented, including but not limited to layout information, placement information, targeting rule information, and association information linking an asset sentence to one or more advertisements.

The term “advertisement information” refers to information generated for advertisement distribution, including at least an asset sentence and advertisement configuration information associated with the asset sentence.

The term “length constraint” refers to a rule or parameter specifying an allowable range or limit for a size of an asset sentence, such as a number of characters, a number of words, or a number of sentences.

The term “expression constraint” refers to a rule or parameter specifying required or prohibited expressions, stylistic properties, tones, or other linguistic conditions that an asset sentence must satisfy.

The term “inappropriate-expression constraint” refers to a rule or parameter specifying that certain expressions, including but not limited to offensive, discriminatory, or policy-violating expressions, must not appear in an asset sentence.

The term “correction process” refers to automated processing applied to an asset sentence to modify, remove, or replace parts of the asset sentence so that the asset sentence satisfies one or more constraints.

The term “distribution apparatus” refers to a computing apparatus or system configured to distribute advertisements, such as an advertisement server, an advertisement exchange, or an advertisement delivery platform.

The term “history information” refers to information representing records of past behaviors or interactions of a user, including but not limited to browsing histories, purchase histories, and response histories to advertisements.

The term “feature information” refers to condensed or summarized information derived from history information or other user information, which represents one or more characteristics of the user in a form suitable for use in prompt generation or model input.

The term “user attribute information” refers to user information expressing relatively static or slowly changing characteristics of a user, such as age, gender, region, interests, or preference categories.

The term “user behavior information” refers to user information expressing behaviors of a user occurring over time, such as page views, content interactions, purchases, clicks, and other actions performed via a terminal.

The term “real time” refers to processing in which updates to information, generation of prompt sentences, generation of asset sentences, and updates to advertisement configuration information are performed with sufficiently low delay to allow advertisement content to be adjusted substantially concurrently with changes in user attribute information or user behavior information.

In one embodiment, a server cooperates with one or more terminals operated by users to generate and deliver advertisement text using a generative AI model in a manner that improves the functioning of the computer system itself. The server executes one or more programs stored in a non-transitory storage device and performs structured data processing, prompt sentence generation, interaction with a language generation apparatus, and constraint-based post-processing of generated advertisement sentences.

The server uses hardware such as a central processing unit, a main memory, a network interface, and a persistent storage device. The server may be implemented on a general-purpose computing platform, such as a rack-mounted computer or a virtual machine instance provided by a cloud computing environment. The server runs system software such as an operating system, and application software such as a web application framework and a backend service. The server may use a relational data management system or a document-oriented data management system to store structured information, advertisement configuration information, and log information.

The terminal uses hardware such as a portable communication device, a display panel, an input interface, and a wireless communication interface. The terminal may be realized by a smartphone, a tablet, a notebook computer, or a desktop computer. The terminal executes client software such as a web browser or a native application. The terminal presents input screens to the user, transmits item information and user information to the server, and receives and displays advertisement information including asset sentences from the server.

The user operates the terminal to input item information relating to a merchandise or service, such as a product category, a price range, and a target segment. The user also operates the terminal to provide user information, such as demographic attributes, preference attributes, and behavior attributes, including behavior histories of the user. The terminal converts the input into structured data elements and transmits the structured data elements to the server over a secure communication channel.

The server stores the received item information and user information as structured information in a storage device. The server represents the structured information using explicit data structures, such as records containing fields for product category, price band, user age range, user interest tags, and aggregated behavior features. The server performs normalization on the stored information by mapping heterogeneous labels and free-text values to canonical codes. For example, the server maps variant text entries indicating “mid price,” “mid-range price,” or “moderate cost” to a single internal label for a medium price band. The server also performs preprocessing, such as converting text data into lower case where appropriate, tokenizing textual descriptors into standardized tokens, and computing derived attributes, such as age groups or interest clusters.

The server aggregates history information from raw behavior logs to create feature information suitable for input into a generative AI model. The server, for example, processes click logs, page view logs, and purchase logs stored in the data management system to compute summary features such as “frequent buyer of outdoor clothing,” “high engagement with technology news,” or “recent interest in home appliances.” The server applies algorithms such as term frequency-inverse document frequency weighting, clustering of behavior events, or embedding-based similarity calculations to compress high-volume behavior histories into low-dimensional feature representations. These representations reduce storage and transmission overhead and enable real-time computation of prompt sentences.

The server generates a prompt sentence by combining the normalized and preprocessed structured information with one or more templates. The server stores templates as parameterized natural-language patterns that include placeholders for item information, user attributes, and behavior-derived feature information. The server selects an appropriate template according to the item category or campaign type and fills the placeholders with normalized values and feature information. The server thereby transforms internal data structures into a coherent natural-language instruction that controls the behavior of the generative AI model.

For example, the server generates a prompt sentence such as:

“Create a Japanese advertising copy for a mid-priced outdoor fashion item targeted at women in their 20s who enjoy camping and hiking. Emphasize stylish yet practical design, and keep the text within 2 short sentences in a friendly, energetic tone.”

In another example, the server generates a prompt sentence such as:

“Generate a concise English advertising copy for a high-end dishwasher targeted at families with small children. Emphasize time-saving and quiet operation, appeal to busy parents who like cooking, limit the text to 1-2 sentences, and use a reassuring, reliable tone.”

The server transmits the generated prompt sentence to a language generation apparatus that executes a generative AI model. The language generation apparatus may be implemented by one or more servers including hardware accelerators such as graphical processing units. The generative AI model may be configured as a transformer-based neural network, in which an encoder-decoder or decoder-only architecture processes sequences of tokens. The model maintains learned parameters in the form of weight matrices and bias vectors across multiple layers, such as multi-head self-attention layers and feed-forward layers.

The server, in an exemplary embodiment, uses a generative AI model that has been trained on a large corpus of text data. The training process includes tokenizing input text into subword units, embedding tokens into continuous vector spaces, and updating model parameters using gradient-based optimization. The model minimizes a loss function, such as a cross-entropy loss between predicted token distributions and ground truth tokens. During training, the model updates weights according to a gradient descent method or a variant such as Adam optimization and can apply techniques such as dropout regularization, layer normalization, and learning rate scheduling. The training data may include generic text data, together with fine-tuning data specific to advertisement language or domain-specific terminology, thereby enabling the model to produce asset sentences that are both fluent and aligned with advertisement needs.

The server configures inference parameters of the generative AI model, such as a temperature parameter that influences randomness, a top-k or top-p sampling parameter that restricts candidate tokens, and a maximum output length parameter. By controlling these parameters, the server adjusts the diversity and length of the generated asset sentences. The server transmits the prompt sentence and the inference parameters to the language generation apparatus through a communication interface using an application protocol, and the language generation apparatus executes the neural network to generate an output sequence of tokens representing candidate advertisement text. The server receives the generated output from the language generation apparatus and reconstructs the asset sentence from the sequence of tokens. The server then executes a constraint-based post-processing module that evaluates the asset sentence with respect to length constraints, expression constraints, and inappropriate-expression constraints. The server, for example, verifies that the number of characters or words of the asset sentence does not exceed limits defined in advertisement configuration information. The server also verifies that the asset sentence conforms to style requirements, such as sentence count, tone, and presence or absence of certain phrases. The server further applies lexical and semantic filters to detect inappropriate expressions, such as offensive terms or phrases that violate content policies.

The server performs these evaluations using deterministic algorithms and, in some embodiments, secondary classification models trained to detect prohibited content. The server, in response to the asset sentence failing one or more constraints, either issues a new prompt to the language generation apparatus with modified conditions, or applies automatic corrections, such as truncating overlong sentences, rewriting specific expressions using predefined substitution rules, or segmenting and recombining parts of the output. These automatic corrections and re-generation operations reduce the need for manual editing by human operators and provide a non-conventional, computer-centric process for enforcing constraints on AI-generated text.

The server associates the validated asset sentence with advertisement configuration information stored in the data management system. The advertisement configuration information may include layout parameters, such as positions of headline text, description text, and call-to-action elements in a visual template; targeting parameters, such as applicable user segments, geographic regions, and device types; and delivery parameters, such as campaign identifiers and scheduling information. The server generates advertisement information that binds the asset sentence to a specific advertisement structure and to a set of targeting rules.

The server transmits the advertisement information to a distribution apparatus or directly to terminals. The distribution apparatus may be an advertisement server or advertisement exchange system that selects and returns advertisement creatives according to targeting rules and auction results. The terminal receives advertisement information and renders the advertisement by placing the asset sentence into the appropriate display element. The terminal may display the advertisement as part of a web page, a mobile application, or another user interface, using graphical rendering engines and text layout mechanisms.

The server, in another embodiment, continuously receives updated user attribute information and user behavior information from terminals or other systems. The server updates the stored structured information and recomputes feature information, such as changes in user interest segments or newly observed purchasing tendencies. The server then regenerates prompt sentences and corresponding asset sentences based on these updates and updates advertisement configuration information accordingly. This continuous update enables advertisements to adapt in near real time to changes in user behavior, such as a sudden increase in interest in certain product categories. By coupling feature aggregation, prompt generation, and constraint-based post-processing in an integrated pipeline, the server improves the responsiveness and relevance of the advertisement generation mechanism. The server improves computer technology in several ways. First, the server reduces redundant data transfers and processing load by converting raw, high-volume behavior histories into compact feature representations before generating prompt sentences. This reduces memory consumption and network traffic between the server and the language generation apparatus. Second, the server localizes business logic for prompt sentence generation and constraint enforcement in a dedicated processing module, thereby enabling the language generation apparatus to focus on sequence modeling and text generation. This modularization reduces computational waste caused by repeated manual prompt authorship and ad-hoc validation in conventional systems.

Third, the server executes non-conventional composition algorithms to construct prompt sentences that explicitly encode constraints and feature information, which are not typically present in manually crafted prompts. For example, the server can construct prompts that specify precise sentence counts, language requirements, and feature-driven appeal points derived from behavior histories. This systematic inclusion of machine-generated feature information leads to asset sentences that are better aligned with underlying user patterns and advertisement requirements, thereby increasing the accuracy and effectiveness of the generated output in a way that a human operator, processing the same data without computational support, would not be able to achieve at scale.

Fourth, the server implements a feedback mechanism in which constraints on the generated asset sentence trigger automatic regeneration or correction. This mechanism creates a closed-loop control within the computer system, where evaluation results drive further processing steps without human intervention. This closed-loop architecture improves robustness, reduces error rates, and lowers latency in producing acceptable advertisement text. The server can further adjust model parameters or prompt formulations dynamically based on past generations and constraint violation statistics, thereby optimizing overall computational performance and output quality.

In still another embodiment, the server uses alternative or additional machine learning models for feature extraction and constraint checking. The server may, for example, employ a separate neural network model trained to classify user behavior sequences into interest categories, or to rank candidate asset sentences according to predicted performance metrics. The server can incorporate these additional models into the pipeline without changing the basic architecture, thereby providing flexibility and extensibility of the system. The use of multiple cooperating models further differentiates the disclosed system from a simple automation of human copywriting tasks and demonstrates an integrated technical solution for controlling text generation, validation, and distribution.

The terminal, in some embodiments, provides an interface that enables the user to review and optionally edit asset sentences before final deployment. The terminal transmits user edits back to the server, and the server records differences between AI-generated and user-edited text. The server may use such records to refine templates, adjust constraint rules, or update training datasets in subsequent learning cycles. This feedback loop can lead to improved generative model performance and more efficient prompt designs, thereby contributing to the continuous improvement of the computer-implemented system.

The described embodiments are not limited to a single merchandise category or advertisement format. The server may apply the same data structures and processing modules to various content domains, such as travel services, financial products, or digital content subscriptions. The server may also adapt the prompt templates for different output languages or cultural styles. Additionally, the server may operate with different generative AI model architectures, including models with different numbers of layers, different attention mechanisms, or different tokenization schemes, as long as the server performs the defined structured information processing, prompt sentence generation, constraint-based validation, and advertisement configuration updates.

By implementing these specific hardware-software interactions, data structures, and algorithms, the server and terminal together realize a concrete technical system that improves the efficiency, accuracy, and responsiveness of computer-implemented advertisement generation and delivery, beyond a mere automation of human mental processes.

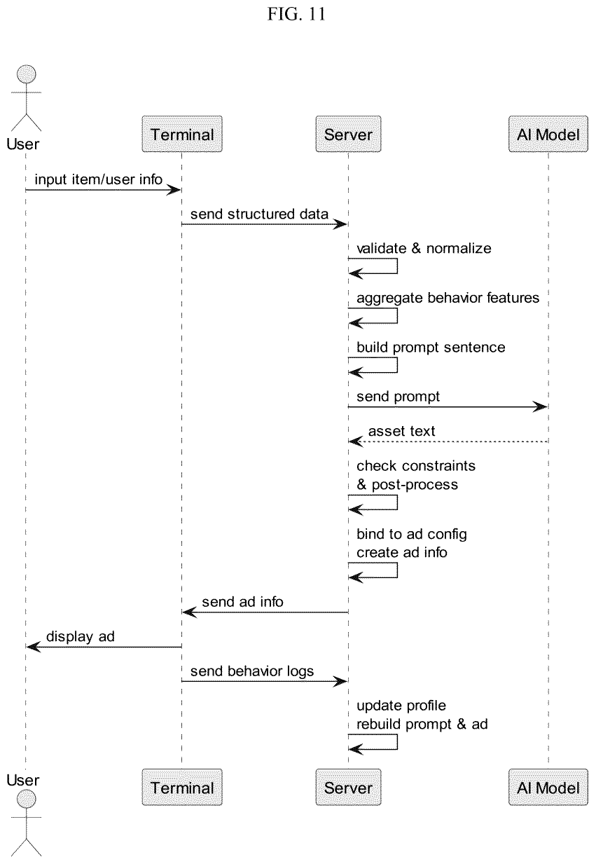

The following describes the processing flow using FIG. 11.

Step 1:

The terminal presents an input screen to the user and collects item information and user information. The terminal receives, as input, raw values such as product category, price range, target segment, user age, user gender, user interests, and behavior history selections entered by the user. The terminal performs basic client-side validation, such as checking that required fields are not empty and that numeric values (for example, age) are within an allowable range. Based on this input, the terminal converts the values into a structured data object, for example by assigning each value to a key (such as “category,” “price_band,” “age,” “interest_tags”) and encoding the object in a serializable format. The terminal outputs the structured data object and transmits it to the server via a network interface.

Step 2:

The server receives the structured data object from the terminal and performs server-side validation. The server takes as input the structured item information and user information sent by the terminal. The server parses the received object, checks presence and type of each required field (for example, verifies that “price_band” is one of predetermined codes and that “age” is a valid integer), and detects missing or invalid values. Based on this validation, the server either generates an error message and sends it back to the terminal or constructs an internal representation of the data using typed records or objects. The server outputs a validated and internally represented data structure for further processing.

Step 3:

The server normalizes and preprocesses the validated item information and user information. The server uses, as input, the internal data structure produced in Step 2. The server maps free-form text and variant labels to canonical codes (for example, converting “mid price” and “medium price” into a standard “MID” label), trims unnecessary whitespace, and converts values to uniform formats (for example, mapping age to an age group code). The server also tokenizes text fields and removes stop words where appropriate, and may compute derived attributes such as “age_group=twenties” or “interest_cluster=outdoor_activities.” The server outputs a normalized and preprocessed structured information object that is consistent and machine-interpretable.

Step 4:

The server aggregates user behavior history into compact feature information. The server takes as input the behavior-related part of the preprocessed user information, including identifiers of past actions such as viewed items, clicked advertisements, and purchased items. The server accesses stored behavior logs in a data management system, filters records belonging to the current user, and applies aggregation functions such as counting occurrences by category, calculating recency scores, and clustering related behaviors. Based on these calculations, the server generates feature descriptors (for example, “frequent_outdoor_buyer,” “recent_interest_in_home_appliances”) and numerical feature vectors summarizing the behavior history. The server outputs an enriched structured information object that contains both the normalized attributes and the derived feature information.

Step 5:

The server selects a prompt template and constructs a prompt sentence for a generative AI model. The server uses, as input, the enriched structured information object from Step 4. The server chooses a template according to factors such as product category, target segment, and campaign type (for example, a fashion template or an appliance template). The server then inserts specific values—such as age group, gender, price band, interest features, and desired tone—into placeholder positions in the template. For example, the server may construct the following prompt sentence as output:

“Create a Japanese advertising copy for a mid-priced outdoor fashion item targeted at women in their 20s who enjoy camping and hiking. Emphasize stylish yet practical design, and keep the text within 2 short sentences in a friendly, energetic tone.”

The server outputs the generated prompt sentence together with metadata such as the selected template identifier and desired output constraints.

Step 6:

The server transmits the prompt sentence to a language generation apparatus executing a generative AI model and obtains an asset sentence. The server takes as input the prompt sentence and associated constraint metadata from Step 5. The server configures generation parameters (for example, temperature, maximum token length, and sampling strategy) and sends a generation request that includes the prompt sentence and parameters to the language generation apparatus over a network connection. The language generation apparatus processes the request by executing a neural network model and returns a sequence of tokens representing generated text. The server receives this token sequence and decodes it into a natural-language string. The server outputs a raw asset sentence, such as an AI-generated advertisement text, for further evaluation.

Step 7:

The server evaluates the raw asset sentence against predefined constraints and optionally regenerates or corrects the sentence. The server uses, as input, the asset sentence generated in Step 6 and the constraint metadata produced in Step 5. The server calculates the length of the asset sentence (for example, character count and sentence count) and checks whether it falls within allowed limits. The server also scans the text for disallowed expressions or stylistic violations using pattern matching, rule-based filters, or trained classifiers. If the asset sentence violates one or more constraints, the server may modify the prompt sentence (for example, tighten length instructions or remove problematic terms) and send a re-generation request to the language generation apparatus, or it may apply automatic corrections such as truncation or phrase substitution. The server outputs a validated and, if necessary, corrected asset sentence that conforms to the specified constraints.

Step 8:

The server associates the validated asset sentence with advertisement configuration information and generates advertisement information. The server takes as input the validated asset sentence from Step 7 and advertisement configuration information retrieved from storage, such as layout parameters, targeting rules, and campaign identifiers. The server combines these inputs by binding the asset sentence to specific layout fields (for example, headline, description) and associating it with a set of targeting criteria (for example, user segment and device type). The server then encapsulates the combined data into an advertisement information structure suitable for distribution. The server outputs the finalized advertisement information that includes the asset sentence as a component of an advertisement creative.

Step 9:

The server distributes the advertisement information to a distribution apparatus or directly to terminals. The server uses, as input, the advertisement information constructed in Step 8. The server selects an appropriate distribution path based on campaign settings, formats the advertisement information for a particular advertisement protocol or application programming interface, and transmits the information over the network. For example, the server may send the advertisement information to an advertisement server that requests creatives in real time, or directly to a terminal that displays a preview. The server outputs the transmitted advertisement payload, and the receiving device (distribution apparatus or terminal) obtains an advertisement that includes the asset sentence in its rendering data.

Step 10:

The terminal receives the advertisement information and renders the advertisement including the asset sentence to the user. The terminal takes as input the advertisement information from the server or from a distribution apparatus. The terminal parses the received structure, extracts layout details and the asset sentence, and maps the text to appropriate user interface components, such as text views or HTML elements. The terminal then renders the advertisement on a display panel, combining text, images, and other media according to the layout instructions. The terminal outputs a visual presentation of the advertisement to the user, who can view or interact with the advertisement through the terminal interface.

Step 11:

The terminal and the user provide feedback and updated behavior information to the server. The terminal receives, as input, user interactions with the advertisement, such as clicks, scrolls, or dismissals, and subsequent navigation or purchase actions. The terminal logs these actions as behavior events with timestamps and context information. The terminal converts the events into structured behavior records and transmits them to the server. The terminal outputs updated user behavior information, which becomes an input to the server for further aggregation and feature extraction.

Step 12:

The server updates stored user information and regenerates prompt sentences and asset sentences in response to new behavior data. The server uses, as input, the behavior records sent from the terminal in Step 11 and the previously stored structured information. The server updates behavior history logs, recomputes aggregated features such as recent interests or engagement levels, and revises the enriched structured information object for the user. Based on these updated features, the server repeats the prompt construction, generative AI model invocation, constraint validation, and advertisement information generation as in Steps 5 through 8. The server outputs newly generated prompt sentences, asset sentences, and updated advertisement information, enabling the system to adapt advertisement content to the latest user behavior in a continuous, technically controlled cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented advertising systems, a server generally selects and displays pre-authored advertisement texts based on coarse user segments and static rules. In such systems, user profile data and product data are often used only for simple matching or filtering, without being integrated into a unified, machine-readable representation that can drive fine-grained natural language generation. As a result, the server typically cannot generate advertisement text that is precisely tailored to a specific combination of user attributes, user behavior, and product characteristics in real time.

Furthermore, in conventional architectures, any use of generative models is often loosely coupled to the surrounding data-processing pipeline. Raw or only partially processed user information and product information are directly passed into a model or rule engine, which causes several technical problems: (i) increased latency due to inefficient preprocessing and model invocation; (ii) instability and inconsistency of generated texts due to noise, missing values, and non-normalized data; and (iii) difficulty in incorporating feedback from user interaction logs into the generation pipeline in a systematic manner. As a result, the computing resources of the server, including processing units and memory subsystems, are not effectively utilized, and the throughput and responsiveness of the ad-serving infrastructure are degraded.

In addition, existing systems generally treat user interaction logs, such as advertisement display histories, click histories, and purchase histories, as data for offline analysis, rather than as first-class learning data that continuously and directly update the conditions for generating prompts and advertisement texts. Without a tightly integrated feedback loop, the system cannot adapt the generative behavior of the model to changing user preferences and market conditions. This leads to lower click-through rates, reduced relevance of displayed advertisements, and inefficient use of network bandwidth and storage resources, because many low-impact advertisements are transmitted and rendered.

Moreover, in many conventional approaches, the server lacks a structured mechanism to generate intermediate prompt sentences that explicitly describe both user context and product context in a standardized natural-language form before invoking a generative AI model. Instead, the model is often invoked with ad hoc inputs or opaque feature vectors. This absence of a well-defined prompt construction stage reduces the controllability and predictability of the generative process, makes it harder to enforce length and expression constraints, and complicates system-level testing and debugging.

Accordingly, there is a need for an improved computer-implemented advertising system in which a processor executes a structured sequence of operations to (i) acquire and preprocess user information and product information into normalized and encoded forms, (ii) generate a prompt sentence that explicitly describes a relationship between a user and a product, (iii) input the prompt sentence into a generative AI model to automatically generate an advertising asset sentence, (iv) validate and format the generated sentence according to technical constraints, and (v) use behavior history information as learning data to update processing conditions and model behavior. Such an improved system can enhance the technical performance of the server by reducing latency, improving the quality and stability of generated advertisement texts, and enabling dynamic, feedback-driven optimization of ad generation.

The specific processing by the specific processing unit 290 of the data processing device 12 in Application Example 1 is realized by the following means.

The present invention provides a server comprising a processor configured to execute instructions to acquire user information including at least attribute information and behavior information from a storage unit or a terminal device and to preprocess the user information including complementing missing values, normalizing numerical values, and encoding categorical values; to acquire product information including at least category information, price information, and target segment information from a storage unit and to preprocess the product information including encoding category information and scaling price information; to generate a prompt sentence that describes a relationship between a user and a product, on a basis of the preprocessed user information and the preprocessed product information, the prompt sentence including at least a description of user attributes and user behavior and a description of characteristics of a product to be advertised; to input the generated prompt sentence into a generative AI model implemented by a machine learning framework and automatically generate an advertising asset sentence corresponding to the prompt sentence; to perform a validation process on the generated advertising asset sentence, the validation process including at least checking compliance with a length constraint, checking compliance with an expression constraint, and determining presence or absence of a prohibited term, and generate a validated advertising asset sentence; to generate advertising information including at least the validated advertising asset sentence, product identification information corresponding to the validated advertising asset sentence, and display control information, and transmit the advertising information to a terminal device in response to an advertising request from the terminal device in real time; to acquire behavior history information from the terminal device, the behavior history information including at least an advertisement display history, an advertisement selection history, and a purchase history associated with the advertising information, and store the behavior history information as learning data for updating the user information and the product information; and to update at least one of a processing condition for generating the prompt sentence and automatically generating the advertising asset sentence and a learning state of the generative AI model, on a basis of the stored behavior history information. This enables an improvement in computer technology by providing a tightly integrated data-processing and generation pipeline that reduces end-to-end latency, stabilizes and constrains generated advertisement text, and adaptively optimizes the behavior of the generative AI model using real-time feedback, thereby enhancing the efficiency and effectiveness of advertisement delivery performed by the server.

The term “user information” refers to information associated with an individual or entity that receives advertisements, including at least attribute information such as age, gender, preferences, and demographic characteristics, and behavior information such as search history, browsing history, advertisement interaction history, and purchase history.

The term “attribute information” refers to information that describes relatively stable characteristics of a user, including but not limited to age, gender, residence area, interests, and declared preferences, which can be used to segment or characterize the user.

The term “behavior information” refers to information that describes actions performed by a user in relation to a service or content, including but not limited to search queries, page views, clicks, scrolls, advertisement interactions, and purchase operations, each associated with at least a timestamp and a content identifier.

The term “product information” refers to information that describes an item or service to be advertised, including at least category information indicating a classification of the item or service, price information indicating a monetary value or range, and target segment information indicating an intended or recommended audience.

The term “category information” refers to information indicating a classification of a product or service into one or more categories, such as type, usage, or domain of the product, which may be represented by labels, codes, or hierarchical category identifiers.

The term “price information” refers to information that indicates a monetary value or range associated with a product or service, including a list price, a discounted price, a price band, or any other value derived therefrom.

The term “target segment information” refers to information indicating a group of users for whom a product or service is intended or recommended, the group being defined by one or more attributes such as age range, gender, interest, lifestyle, or purchasing behavior.

The term “preprocess” refers to a sequence of operations performed on raw data to convert the raw data into a normalized or encoded form suitable for further computation or model input, including at least complementing missing values, normalizing numerical values, and encoding categorical values.

The term “normalizing numerical values” refers to transforming numerical data, such as age or price, into a standardized scale or range, such as by scaling, standardization, or other mathematical transformation, to improve stability or performance of subsequent computation or modeling.

The term “encoding categorical values” refers to converting categorical data, such as a category label or gender value, into a numerical or symbolic representation, such as an index, vector, or binary indicator, that can be processed by a machine learning model or other computation.

The term “prompt sentence” refers to a natural-language text expression generated on the basis of user information and product information, the natural-language text expression explicitly describing at least user attributes and user behavior and characteristics of a product to be advertised, and being used as input to a generative AI model.

The term “generative AI model” refers to a machine-learned model implemented using a machine learning framework and configured to generate text or other content in response to input data, such as a prompt sentence, the model being trained on example data and capable of producing context-dependent outputs.

The term “advertising asset sentence” refers to a natural-language text segment generated by the generative AI model on the basis of a prompt sentence, the text segment being intended for use as advertisement copy or a textual component of an advertisement.

The term “validation process” refers to a set of operations executed to check and modify, if necessary, a generated advertising asset sentence to ensure compliance with predetermined technical or business rules, including checking a length constraint, checking an expression constraint, and determining presence or absence of a prohibited term.

The term “length constraint” refers to a condition specifying allowable limits on a size of a text, such as a maximum number of characters, tokens, or words, used to ensure that a generated advertising asset sentence fits within a designated display area or system requirement.

The term “expression constraint” refers to a condition specifying allowable forms, tones, or styles of text, such as formality level, avoidance of certain phrases, or inclusion of specified elements, used to control wording of a generated advertising asset sentence.

The term “prohibited term” refers to a word, phrase, or expression that is not allowed to appear in a generated advertising asset sentence due to legal, ethical, policy, or quality-control reasons, and that is checked for and removed or replaced during the validation process.

The term “validated advertising asset sentence” refers to an advertising asset sentence that has undergone the validation process and has been confirmed or modified to comply with at least the length constraint, the expression constraint, and the prohibited term condition.

The term “advertising information” refers to data generated for delivery of an advertisement to a terminal device, including at least a validated advertising asset sentence, product identification information corresponding to the validated advertising asset sentence, and display control information.

The term “product identification information” refers to information that uniquely or specifically identifies a product or service to be advertised, such as a product ID, code, or link, which is associated with an advertising asset sentence.

The term “display control information” refers to information used to control how, where, or when an advertisement is presented on a terminal device, including but not limited to layout parameters, priority values, placement positions, and validity periods.

The term “terminal device” refers to an electronic apparatus that communicates with a server over a communication network and presents advertisements to a user, including but not limited to a smartphone, tablet, personal computer, or other display-capable device.

The term “behavior history information” refers to accumulated data representing a sequence of user actions related to advertisements and products, including at least advertisement display history, advertisement selection history, and purchase history, each associated with identifiers and timestamps.

The term “advertisement display history” refers to information indicating which advertisements were presented on a terminal device, at what time, and optionally in what position or context, for a particular user or device.

The term “advertisement selection history” refers to information indicating user interactions with advertisements, such as clicks, taps, or other selection actions, including at least identifiers of selected advertisements and associated timestamps.

The term “purchase history” refers to information indicating transactions completed by a user, including identifiers of purchased products or services, quantities, times of purchase, and optionally prices or transaction identifiers.

The term “learning data” refers to data used to update or adapt processing conditions or a machine-learned model, including but not limited to behavior history information that is stored and later used to refine prompt generation, text generation, or model parameters.

The term “processing condition” refers to one or more parameters, rules, thresholds, or configurations that govern how a system generates a prompt sentence or an advertising asset sentence, including settings for preprocessing, prompt construction, model invocation, or post-processing.

The term “learning state of the generative AI model” refers to information that defines or reflects the internal configuration of the generative AI model, such as weights, biases, hyperparameters, or other parameters that are updated during training or adaptation.

The term “real time” refers to operation in which a server responds to a request from a terminal device and generates and transmits advertising information within a time interval sufficiently short that the resulting advertisement can be displayed without perceptible delay to a user during ongoing interaction.

The term “machine learning framework” refers to a software environment or library for implementing and executing machine-learned models, including functions to define model architectures, perform training, and perform inference for the generative AI model.

The term “storage unit” refers to any hardware or logical component configured to store data used by the system, including but not limited to semiconductor memory, magnetic storage, optical storage, or a storage service in a networked environment.

The term “server” refers to a computing apparatus or a set of computing apparatuses that provide data processing, storage, and communication functions, and that include at least one processor configured to execute instructions to perform operations described in the system.

The term “processor” refers to one or more hardware processing units or circuits, such as a central processing unit, a graphics processing unit, or another computation unit, capable of executing instructions to perform logical, arithmetic, and control operations.

In one embodiment, a server implements the claimed system by executing a computer program on one or more processors, such as central processing units and graphics processing units, in cooperation with a main memory, a non-volatile storage device, and a network interface. The server runs an operating system, such as a general-purpose server operating system, and middleware including a web application framework, a relational database system, and a machine learning framework such as a neural network library. The server stores user information, product information, and model parameters in a storage unit implemented by magnetic storage, semiconductor memory, or a network storage service.

The server manages user information as records in a structured data storage. Each user record contains attribute information, such as age, gender, declared interests, and region, and behavior information, such as search history, page view history, advertisement interaction history, and purchase history. The server represents these records using relational tables or key-value data structures. For example, the server stores an age field as an integer column, a gender field as a categorical column, and a list of recently viewed product categories as a variable-length array or a separate log table linked by a user identifier.

The server manages product information in a similar structured manner. The server maintains, in a product table, category information (for example, a category code representing “running shoes”), price information (for example, a numeric field representing list price and a numeric field representing discount price), and target segment information (for example, codes representing “males in their 30s who like running”). The server uses indexes on product identifiers and category codes to accelerate access when constructing advertisements.

The server preprocesses user information and product information using application software implemented in a general-purpose programming language and data-processing libraries. The server performs missing-value completion by scanning each user record and filling undefined age values with a median age computed for a corresponding user segment, and by setting undefined interest flags according to default rules. The server normalizes numerical fields, such as age, purchase count, and product price, by applying linear scaling or z-score transformation to map values into standardized ranges. The server encodes categorical fields, such as gender, category information, and target segment information, into machine-usable representations, for example, one-hot vectors or learned embedding indices. These preprocessing operations are executed in memory on structured data arrays, which reduces the dimensionality mismatch and instability that would otherwise occur if raw, inconsistent data were directly used as model input.

The server constructs a prompt sentence in natural language on the basis of the preprocessed user information and product information. The server generates the prompt sentence by inserting normalized attribute values and product characteristics into a template held in the storage unit. For example, when the user is male, in his 30s, enjoys running, and has recently searched for running shoes, and the product is new running shoes at a mid-range price with a 20% discount, the server may generate a prompt sentence such as:

“User: male in his 30s, enjoys running, recently searched for running shoes. Product: new running shoes, mid-price range, suitable for daily training, currently 20% off. Using a friendly tone, generate one short, persuasive advertisement sentence in English.”

In another example, when the user is female, in her late 20s, likes hiking and outdoor activities, and has recently viewed trekking backpacks, and the product is waterproof hiking boots for weekend trails, the server may generate a prompt sentence such as:

“User: female, late 20s, likes hiking and outdoor activities, recently viewed trekking backpacks. Product: waterproof hiking boots, mid-price range, designed for weekend trails. Generate a single English ad sentence that emphasizes comfort and durability.”

The server uses these prompt sentences as direct inputs to a generative AI model implemented as a neural network. In one embodiment, the generative AI model is a transformer-based language model having multiple self-attention layers, feed-forward layers, and layer normalization units. The server represents the prompt sentence as a sequence of token identifiers, each corresponding to a word or subword unit, and embeds these token identifiers into high-dimensional vectors using an embedding matrix stored in memory. The server then processes the sequence through the transformer layers, computing attention scores between tokens, weighted sums of token representations, and non-linear activations. The model parameters, including weights of the attention projections and feed-forward layers, are stored in the storage unit and loaded into main memory for inference.

The server trains or fine-tunes the generative AI model using a corpus of training examples that include pairs of prompt sentences and desired advertising asset sentences. During training, the server computes a loss function such as a cross-entropy loss between predicted token distributions and ground-truth tokens. The server performs backpropagation to compute gradients with respect to model parameters and then updates the parameters by using an optimization algorithm such as stochastic gradient descent with momentum or an adaptive gradient method. The server may perform data augmentation by varying wording of prompt sentences or by sampling alternative but equivalent user and product descriptions, thereby improving model robustness and coverage.

The server executes inference by passing the prompt sentence through the trained model and generating an advertising asset sentence token-by-token. The server controls generation by setting parameters such as maximum output length, temperature, and probability thresholds for sampling. The server selects tokens using algorithms such as top-k sampling or nucleus sampling, and concatenates the selected tokens into a natural-language sentence. This algorithmic procedure is not a mere automation of human writing, because the server evaluates large combinatorial spaces of possible word sequences at machine speed and applies learned high-dimensional representations that cannot be processed manually in real time.

The server validates the generated advertising asset sentence by executing a validation module. This module parses the output string, counts characters or tokens to ensure that a length constraint is satisfied, scans for prohibited terms by comparing tokens against a blacklist stored in a lookup table, and enforces expression constraints, such as requiring a call-to-action phrase or preventing certain stylistic patterns. When the server detects violations, the server may truncate the sentence, replace specific words, or request regeneration with modified parameters. Because this validation is performed programmatically at the server-side, the server maintains consistency and compliance across a large number of dynamically generated advertisements without human intervention.

The server creates advertising information by combining the validated advertising asset sentence with product identification information and display control information. For example, the server associates a product identifier, a hyperlink, and an image resource identifier with the advertising asset sentence, and adds control parameters such as display position, priority, and expiration time. The server stores this advertising information as a structured object and transmits it to a terminal over a communication network, such as a packet-switched network, using a communication protocol. The server responds to advertisement requests in real time, such that the generated advertisement appears to the user without noticeable delay during browsing.

The terminal operates as a client device, such as a smartphone or personal computer, that communicates with the server. The terminal receives the advertising information from the server via a network interface and processes the received data using a browser or application software. The terminal loads the product image from a specified resource and renders a user interface element such as a banner or card. The terminal inserts the validated advertising asset sentence into a text field, arranges layout according to the display control information, and presents the advertisement on a display unit. The terminal records user interactions, such as impressions, clicks, and purchases, as events tied to advertisement identifiers.

The terminal transmits behavior history information containing advertisement display history, advertisement selection history, and purchase history to the server. The server receives the behavior history information and writes it into a log storage structure, such as an append-only log or a message queue, and then aggregates the logs into user-level statistics. The server updates interest scores for product categories, click-through rates for specific prompts and asset patterns, and conversion indicators for different types of products. The server uses this behavior history information as learning data to adjust processing conditions and to fine-tune the generative AI model.

The server updates processing conditions by, for example, adjusting the composition of prompt sentences. When the server detects that prompt sentences including explicit discount wording produce higher interaction rates, the server may modify templates to more prominently include discount information. The server may also update parameters for the generative AI model, such as the weight given to certain special tokens that indicate emphasis on price or limited-time offers. Because these updates are driven by measured user behavior and implemented as changes to data structures and model weights, the server improves the technical performance of the system: advertisement relevance increases, the number of ineffective transmissions decreases, and bandwidth and processing resources are used more efficiently.

The server achieves a technical improvement over conventional systems by performing structured preprocessing and prompt construction. By normalizing and encoding user information and product information before prompt generation, the server reduces the variance and noise in model inputs, which leads to more stable generation and shorter inference time, because the model no longer needs to implicitly adapt to unstructured data. By explicitly forming a prompt sentence with a standardized structure, the server constrains the input space presented to the generative AI model, which improves the predictability of the output distribution and reduces the need for post-hoc filtering. This in turn reduces the number of regeneration cycles, decreasing CPU and GPU load and lowering latency. Furthermore, the server improves data management by using explicit data structures for user profiles, product catalogs, and behavior logs. The server uses indexing, caching, and incremental updates to access relevant subsets of data quickly. This design allows the server to respond efficiently even under high request volumes. The integrated feedback loop, in which behavior history information is used to update both user information and processing conditions for prompt and asset generation, enables continuous optimization at the system level. This feedback loop is implemented through concrete update algorithms, rather than through purely abstract decision-making.

In an alternative embodiment, the server deploys different variants of the generative AI model with different architectures or sizes. For example, the server may use a smaller transformer network for low-latency scenarios and a larger network for high-value placements. The server selects which model to invoke based on current load, latency requirements, and expected benefit, and records performance metrics. The server may also vary the training strategy, such as using curriculum learning where simpler prompts are used first in fine-tuning, then more complex contexts, to stabilize convergence. These variations show that the invention is not limited to a single model configuration and that the architecture can be adapted to different computing environments while retaining the core technical benefits.

In another embodiment, the server incorporates rule-based pre-filters before invoking the generative AI model. For instance, the server may exclude products with out-of-date information or with low inventory by checking flags in the product information. The server may also enforce hierarchical prompts that first describe the user at a high level, then product characteristics, and finally a required tone or call-to-action. This non-conventional ordering of prompt components, derived empirically from system performance, supports improved generation quality and reduces computation wasted on unsuitable products.

The described embodiments demonstrate that the server does not merely automate human advertising copywriting. Instead, the server implements a specific data-processing architecture, neural network configuration, and feedback-driven optimization pipeline that improves computational efficiency, reduces communication overhead, and enhances the quality and stability of generated advertisement texts. By integrating preprocessing, structured prompt generation, constrained generative modeling, and behavior-based adaptation, the system provides a concrete improvement in computer technology in the field of network-based advertisement delivery.

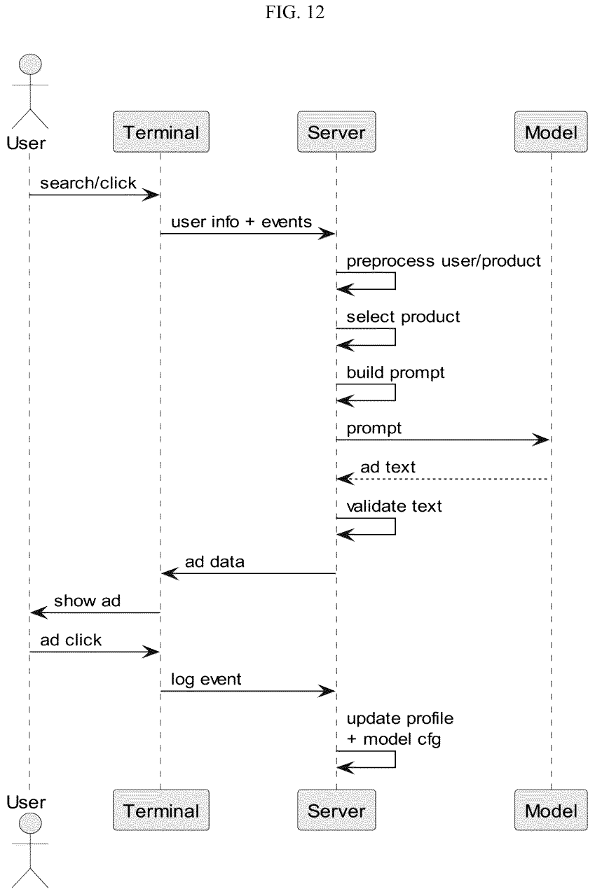

The following describes the processing flow using FIG. 12.

Step 1:

The user operates the terminal to perform actions such as searching, browsing, and purchasing.

The input is a user's operation, for example typing a search query, tapping a product, or clicking an advertisement.

The terminal converts the user's operations into structured event records including at least an event type (such as search, view, click, or purchase), a timestamp, and one or more identifiers (such as user identifier and product identifier).

The terminal stores these event records temporarily in a local buffer or sends them immediately to the server via a communication interface.

Step 2:

The terminal transmits user attribute information and behavior information to the server.

The input is user attributes stored on the terminal (such as age, gender, declared interests) and the event records generated in Step 1.

The terminal packages this information into a structured message, for example by constructing a data object that includes user identifier, attribute fields, and a list of recent events.

The terminal sends the packaged message to the server over a network connection using a request to a server endpoint, and the output is a network message received by the server.

Step 3:

The server stores and aggregates the received user information.

The input is the structured message received from the terminal in Step 2.

The server parses the message, extracts user identifier, attribute information, and behavior information, and writes these elements into persistent data structures such as profile tables and log tables.

The server merges the new information with existing records by updating the corresponding profile entry and appending behavior events to a history log, and the output is an updated user profile and an updated behavior history associated with that user.

Step 4:

The server preprocesses the user information into a normalized and encoded representation.

The input is the updated user profile from Step 3, including raw attribute values and accumulated behavior history.

The server applies data-processing operations such as:
filling missing attribute values with default or statistically derived values,
computing aggregate metrics from behavior history, such as counts of views per category and recency scores,
normalizing numerical attributes into a fixed range, and
encoding categorical attributes into numeric indices or vectors.

The server outputs a preprocessed user feature set, which includes normalized numerical fields and encoded categorical fields suitable for subsequent computation.

Step 5:

The server retrieves and preprocesses product information for candidate advertisement items.

The input is a product selection context, for example a list of product identifiers relevant to the current page or campaign conditions.

The server queries a product storage unit to obtain raw product records that include category information, price information, and target segment information.

The server encodes category labels and target segment codes into numerical representations, scales price-related values, and creates derived fields such as discount ratio or inventory status.

The server outputs a preprocessed product feature set for each candidate product.

Step 6:

The server selects one or more product candidates to be used for advertisement generation.

The input is the preprocessed user feature set from Step 4 and the preprocessed product feature sets from Step 5.

The server calculates relevance scores using a selection algorithm, for example computing similarity between user interest vectors and product category vectors, and applying rule-based filters that exclude products with expired campaigns or insufficient stock.

The server ranks the candidate products according to the scores and selects at least one product with the highest ranking, and the output is a selected product set that will be used in subsequent generation steps.

Step 7:

The server constructs a prompt sentence describing the user and the selected product.

The input is the preprocessed user feature set and the selected product set from Step 6.

The server transforms numerical and categorical features back into human-readable descriptors, for example converting an age range into “in his 30s” and converting a category code into “running shoes.”

The server inserts these descriptors into a predefined template or assembles them following a predefined structure to produce a natural-language prompt sentence.

For example, the server may generate a prompt sentence such as:

“User: male in his 30s, enjoys running, recently searched for running shoes. Product: new running shoes, mid-price range, suitable for daily training, currently 20% off. Using a friendly tone, generate one short, persuasive advertisement sentence in English.”

The output is the constructed prompt sentence ready for input to the generative AI model.

Step 8:

The server encodes the prompt sentence into token sequences and performs inference using the generative AI model.

The input is the prompt sentence created in Step 7.

The server segments the prompt sentence into tokens according to a tokenizer, maps each token to a token identifier, and then maps each identifier to a dense embedding vector using an embedding matrix stored in memory.

The server feeds the sequence of embedding vectors into a neural network model, such as a transformer-based generative AI model, and executes forward propagation layer by layer to compute probability distributions over next tokens at each generation step.

The server outputs a sequence of predicted token identifiers that correspond to an advertising asset sentence.

Step 9:

The server decodes the generated token sequence into a text advertising asset sentence.

The input is the sequence of predicted token identifiers from Step 8.

The server applies a decoding algorithm, such as greedy decoding, top-k sampling, or nucleus sampling, to select a specific token at each time step, converts each token identifier back to its corresponding text fragment, and concatenates the fragments into a human-readable sentence.

The server outputs the generated advertising asset sentence, for example:

“Lightweight running shoes now 20% off-perfect for your daily runs, grab your pair this week!”

Step 10:

The server performs validation and correction on the generated advertising asset sentence.

The input is the generated advertising asset sentence from Step 9.

The server counts characters or words to determine whether the sentence satisfies a predefined length constraint, scans the sentence using a dictionary or pattern-matching mechanism to detect prohibited terms, and checks expression constraints such as the presence of a call-to-action phrase. If constraints are not satisfied, the server truncates overly long parts, replaces prohibited terms with permitted alternatives, or requests regeneration by adjusting generation parameters.

The server outputs a validated advertising asset sentence that satisfies all applied constraints.

Step 11:

The server assembles advertising information and transmits it to the terminal in response to an advertisement request.

The input is the validated advertising asset sentence from Step 10, together with the identification and display parameters of the selected product.

The server constructs an advertising information object that includes at least the validated advertising asset sentence, product identification information, and display control information such as placement position and priority.

The server sends this advertising information object to the terminal through a communication interface as a response message, and the output is a transmitted advertisement payload received by the terminal.

Step 12:

The terminal renders and displays the advertisement to the user.

The input is the advertisement payload received from the server in Step 11.

The terminal parses the payload to extract the advertising asset sentence, product identifier, and display control parameters, and loads related resources such as product images as needed.

The terminal creates a user interface element, places the text and image according to the display control information, and draws the advertisement on the display unit so that the user can see the generated advertisement in real time.

The output is a visible advertisement presented on the terminal screen.

Step 13:

The user interacts with the displayed advertisement, and the terminal records interaction events.

The input is the user's action on the displayed advertisement, such as tapping the ad, ignoring it, or proceeding to purchase the advertised product.

The terminal detects the action using input sensors such as a touch screen interface, generates an interaction event entry that includes at least the advertisement identifier, the type of action, and a timestamp, and associates it with the current user identifier or device identifier.

The terminal stores this event entry locally or immediately sends it to the server, and the output is a structured interaction event ready for transmission or storage.

Step 14:

The terminal transmits behavior history information to the server for logging and learning.

The input is the interaction event entry or a batch of entries created in Step 13.

The terminal groups multiple events, if needed, into a single message and sends the message to a server endpoint designed for logging advertisement events.

The server receives the message, parses it to extract advertisement display history, advertisement selection history, and purchase history information, and appends these to corresponding log structures.

The output is an updated behavior history dataset stored at the server side.

Step 15:

The server updates user profiles and adjusts processing conditions and model parameters based on the behavior history.

The input is the updated behavior history dataset from Step 14 together with existing user profiles and model configuration values.

The server computes statistics such as click-through rates per product category, conversion rates per prompt pattern, and response distribution over different asset phrasing styles, and updates user interest indicators and preference scores.

The server adjusts processing conditions for future runs, for example by modifying prompt templates or selection thresholds, and may update the generative AI model's learning state by performing further training on newly collected examples.

The server outputs refined user profiles, updated processing conditions, and, when training is performed, updated model parameters, which are then used as inputs in subsequent repetitions of Steps 4 through 11.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented advertising systems typically rely on static rule-based templates and manually authored text fragments to generate advertising content. In such systems, a processor usually selects one of a limited set of pre-stored text assets based on coarse-grained user attributes or campaign parameters, and simply inserts the selected text into a fixed-format advertisement. Because the text assets and selection rules are prepared in advance and are not systematically updated based on actual user interactions, these systems exhibit several technical drawbacks.

First, these systems do not effectively exploit context-sensitive natural language generation capabilities. Even when a generative AI model is introduced, a processor often sends a simplistic, fixed prompt sentence to the model, without dynamically constructing or updating the prompt sentence based on real-time user behavior, feedback, or performance data. As a result, the generative AI model operates in a suboptimal input space, and the generated advertising text is not consistently aligned with user response patterns, leading to low computational efficiency in terms of model usage and weak personalization.

Second, in many existing architectures, there is no integrated feedback loop at the system level between the generative AI model outputs and the user's subsequent behavior or evaluation. User interactions, such as clicks, dwell time, or explicit approvals and corrections, are often logged in isolated analytics modules that are not directly coupled to the logic that constructs prompt sentences or configures the generative AI model. Consequently, the processor cannot automatically refine the control conditions or the prompt construction rules in a structured manner, and must rely on manual tuning by human operators. This separation between generation and feedback increases latency for improvement, wastes computing resources on ineffective generations, and degrades the overall performance of the advertising delivery pipeline.

Third, existing systems generally lack technical mechanisms for post-processing and quality control of generated text at the processor level, such as automatic evaluation of length, expression content, and prohibited expressions, followed by conditional re-generation with modified prompts. Without such mechanisms, the system may deliver unsuitable or non-compliant text to user terminals or may require human review at scale, which introduces additional processing overhead and delays. This absence of automated, model-aware text evaluation and re-generation reduces the robustness and reliability of the end-to-end computer system.

Accordingly, there is a need for an improved computer-based system and method in which a processor cooperates with a generative AI model and a terminal to: (i) construct and update prompt sentences in a dynamic and data-driven manner; (ii) generate advertising text while enforcing machine-executable quality constraints; and (iii) close the loop between user behavior, explicit feedback, and subsequent generations. Such a system should technically improve the way computing resources are orchestrated-at the server, advertising management apparatus, and terminal-to generate, evaluate, update, and redistribute personalized advertising content in real time, thereby enhancing the efficiency, accuracy, and adaptability of the underlying computer technology itself.

The specific processing by the specific processing unit 290 of the data processing device 12 in Example 2 is realized by the following means.

The present invention provides a server comprising a processor, the processor being configured to receive target information and user information as input data from at least one terminal or storage device; to generate instruction information for constructing a prompt sentence as an instruction text that directs a generative AI model to generate advertising character information on the basis of the target information and the user information; to transmit the prompt sentence together with the target information and the user information to the generative AI model as an external processing apparatus or an internal processing mechanism and to cause the generative AI model to automatically generate the advertising character information; to evaluate the automatically generated advertising character information with respect to at least length, expression content, and presence or absence of prohibited expressions, to process the advertising character information according to a result of the evaluation, and, when necessary, to modify the prompt sentence and execute automatic generation by the generative AI model again; to insert the automatically generated or processed advertising character information into advertising configuration information to constitute advertising information and to transmit the advertising information to an advertising distribution management apparatus; to cause advertising including the advertising character information to be displayed on the terminal by outputting the advertising information distributed from the advertising distribution management apparatus to the terminal; to acquire evaluation information and correction request information input by a user via the terminal and to store the evaluation information and the correction request information as record information in association with the target information and the user information; and to generate control information for improving performance of advertising character information to be generated later by updating configuration rules of the prompt sentence or control conditions for the generative AI model on the basis of the record information. This enables the server to technically improve operation of the computer-implemented advertising system by dynamically coupling prompt construction, model invocation, automatic quality evaluation, and feedback-driven configuration updates, thereby increasing the efficiency, reliability, and personalization capability of generative AI-based advertisement generation and distribution.

The term “target information” refers to information that characterizes an object of advertisement, including but not limited to product information, service information, campaign information, category information, feature information, and other descriptive attributes used by a processor to generate advertising character information.

The term “user information” refers to information related to an individual or group that is a potential recipient of advertising, including but not limited to demographic attributes, interest attributes, preference attributes, segment attributes, and historical interaction attributes associated with use of an information processing system.

The term “prompt sentence” refers to an instruction text supplied as input to a generative AI model, the instruction text defining a requested content type, style, constraint, or other generation condition for automatically generating advertising character information.

The term “instruction information” refers to data specifying how to construct a prompt sentence and how to control a generative AI model, including rules, templates, parameters, and control tokens that are used by a processor to form the prompt sentence.

The term “generative AI model” refers to an artificial intelligence model configured to generate data, such as text, in response to input data, and including but not limited to a machine learning model, a neural network model, or a natural language processing model that outputs advertising character information based on a prompt sentence.

The term “advertising character information” refers to text data that constitutes at least a part of an advertisement, including but not limited to sentences, phrases, and expressions that describe a target object, convey an advertising message, or promote a product or service.

The term “external processing apparatus” refers to a processing resource that is separate from a primary server apparatus, including but not limited to a remote server, a cloud computing resource, or a dedicated accelerator device, that executes at least a part of processing of a generative AI model.

The term “internal processing mechanism” refers to a processing resource that is incorporated in a server apparatus, including but not limited to a central processing unit, a graphics processing unit, or a specialized accelerator, that executes at least a part of processing of a generative AI model.

The term “prohibited expressions” refers to expressions that are not allowed to be included in advertising character information, including but not limited to expressions violating legal regulations, platform policies, content guidelines, or advertiser-specific constraints.

The term “advertising configuration information” refers to data defining a structure or layout of an advertisement, including but not limited to a template, a frame, a field definition, a placement definition, and metadata specifying where and how advertising character information is to be inserted.

The term “advertising information” refers to data representing an advertisement ready for distribution, including a combination of advertising configuration information and advertising character information, and optionally including media resource references, targeting parameters, and delivery control parameters.

The term “advertising distribution management apparatus” refers to an information processing apparatus that manages distribution of advertising information, including but not limited to selection, scheduling, targeting, and delivery of advertisements to terminals.

The term “terminal” refers to an information processing device used by a user to receive and display advertisements, including but not limited to a mobile device, a tablet device, a desktop device, or any other computing device having a display function and communication capability.

The term “evaluation information” refers to information indicating a user's assessment of advertising character information or advertising information, including but not limited to explicit approval, rejection, rating, comment, or selection data.

The term “correction request information” refers to information indicating a user's request for modification of advertising character information or advertising information, including but not limited to requests for tone change, length adjustment, content emphasis, or removal of specific expressions.

The term “record information” refers to information stored for later reference and analysis, including but not limited to associations among target information, user information, prompt sentences, generated advertising character information, evaluation information, correction request information, and user behavior information.

The term “control information” refers to information used by a processor to control operation of a generative AI model or prompt construction, including but not limited to configuration rules, parameter values, thresholds, and selection policies that influence generation of advertising character information.

The term “configuration rules of the prompt sentence” refers to rules that define structure, content, and composition of a prompt sentence, including but not limited to ordering of elements, inclusion or exclusion of specific attributes, wording patterns, and parameterization for different user segments.

The term “control conditions for the generative AI model” refers to conditions that determine how a generative AI model performs generation, including but not limited to model selection, decoding parameters, maximum token length, style constraints, and safety filters.

The term “user attribute information” refers to a subset of user information that characterizes inherent or relatively stable properties of a user, including but not limited to age group, gender category, language preference, interest category, and geographic region.

The term “user behavior information” refers to information indicating dynamic actions of a user in relation to content or advertisements, including but not limited to click events, view durations, scroll actions, conversion events, and interaction sequences captured by an information processing system.

The term “behavior information of the user” refers to user behavior information that is associated with one or more pieces of advertising information or advertising character information and that is used to evaluate effectiveness or relevance of generated content.

The term “output conditions of the generative AI model” refers to parameters or constraints that influence format, style, or quantity of generated advertising character information, including but not limited to maximum length, output language, tone, and diversity settings.

The term “real time” refers to processing that is performed with latency sufficiently low that updated advertising information can be delivered and displayed to a terminal substantially immediately in response to updated user attribute information or user behavior information, within a time interval acceptable for interactive use.

In one embodiment, a server functions as a central information processing apparatus that cooperates with at least one terminal and at least one advertising distribution management apparatus. The server comprises a processor, a main memory, a non-volatile storage device, a network interface, and optionally an accelerator such as a graphics processing unit. The server executes an operating system such as a general-purpose server operating system and application software implementing the functions described below. The server communicates with the terminal and the advertising distribution management apparatus via a communication network such as the Internet using a protocol such as HTTPS.

The terminal functions as a user-side information processing device that allows a user to input a prompt sentence and to view advertising information generated by the server. The terminal comprises a processor, a memory, a display device, an input device such as a touch panel, and a wireless or wired communication interface. The terminal executes a client application such as a web browser or a native application that communicates with the server.

The user operates the terminal to input target information and user information, and to confirm, evaluate, and correct advertising character information provided by the server. The user interacts with user interface components such as text input fields, buttons, and confirmation dialogs rendered on the display of the terminal.

The server stores target information, user information, and generated advertising character information in data structures managed by a database system such as a relational database. The server represents each piece of target information by a record including fields such as a target identifier, a category identifier, a list of feature descriptors, and a set of campaign parameters. The server represents each piece of user information by a record including fields such as a user identifier, one or more attribute categories, an interest vector, and a behavior history summary. The server represents each generated advertising text by a record including a reference to the originating prompt sentence, a reference to the associated target information, a reference to the associated user information or segment, and one or more quality scores computed by the server.

The server uses a generative AI model implemented as a neural network, for example a transformer-based language model configured with a plurality of self-attention layers, feedforward layers, and layer normalization units. The generative AI model has been trained beforehand on a corpus of text data by an optimization algorithm such as stochastic gradient descent or an adaptive variant. The training process minimizes a loss function such as cross-entropy between predicted token probabilities and actual tokens in the training data. The server stores or accesses model parameters including weight matrices, bias vectors, and embedding vectors. The server may access the generative AI model as an internal processing mechanism deployed on the same hardware platform, or as an external processing apparatus provided by a remote computing resource.

The server generates a prompt sentence by executing a prompt construction module implemented as software instructions. The prompt construction module operates on structured data stored in memory. The server retrieves target information and user information corresponding to a current generation request and converts these into textual descriptors using rule-based templates. For example, the server converts an internal feature descriptor “battery_life=long” into a textual phrase such as “long battery life,” and converts an interest category “segment=tech_20s_30s” into a textual phrase such as “users in their 20s and 30s who are interested in technology.” The server concatenates such textual descriptors with fixed instruction segments to form the prompt sentence.

For example, the server constructs a prompt sentence such as:

“You are a marketing copywriter. Generate a short advertising sentence in English for online use. Target users are in their 20s and 30s who are interested in technology. The product is a high-performance laptop with long battery life. Please create an ad sentence that emphasizes the features of the new product.”

In another example, the user operates the terminal to input a more specific prompt sentence. The terminal displays a text input area and the user inputs text such as:

“Please create a more casual and friendly ad sentence suitable for social media users in their 20s.”

“Generate three short ad headlines highlighting the eco-friendly features of our new cleaning product.”

“Write an advertisement text that appeals to middle-aged users who are interested in health and fitness, focusing on the convenience of our new wearable device.”

The terminal sends the prompt sentence and identifiers of selected target information to the server. The server receives these data items and augments the user-supplied text by adding system-level instructions and contextual descriptors as described above. The server thus forms a final prompt sentence that includes both the user's request and the system-derived context.

The server converts the final prompt sentence into an internal representation used by the generative AI model. The server uses a tokenizer component to segment the prompt sentence into tokens and convert each token into an integer index by referencing a token vocabulary. The server stores the sequence of token indices in a memory buffer and passes this buffer to the generative AI model. The server specifies model control parameters such as a maximum output length, a sampling temperature, and a top-k or top-p sampling threshold. These parameters are part of the control conditions for the generative AI model.

The server performs the generation by causing the generative AI model to compute, for each decoding step, a probability distribution over possible next tokens. The model uses a stack of self-attention layers in which each layer computes attention weights between tokens in the input sequence and the partial output sequence. The model then multiplies these weights by embedding vectors to produce context-aware representations. This architecture enables the server to capture long-range dependencies between different parts of the prompt sentence, such as links between user attributes, target features, and requested tone. The server samples or selects the next token using the specified control conditions and appends it to the output sequence. The server repeats this procedure until an end-of-sequence token is produced or a maximum token count is reached.

The server performs post-processing on the generated token sequence by converting tokens back into characters using the vocabulary mapping and concatenating them to produce advertising character information. The server then evaluates this advertising character information using a quality evaluation module. The quality evaluation module includes rules to measure length, such as counting the number of characters or tokens, and to compare the result against a target range. The quality evaluation module includes pattern-matching rules or a classification sub-model to detect prohibited expressions defined in a policy dataset. The server may compute a score vector for each generated output, such as a length deviation score, a compliance score, and a style consistency score.

When the server determines that the advertising character information does not meet one or more criteria, the server modifies the prompt sentence using a non-conventional rule set and triggers re-generation. For example, when the advertising character information exceeds a desired length, the server appends an additional instruction such as “The sentence must be less than 80 characters.” When the content is detected to be too formal for a particular segment, the server inserts an instruction such as “Use casual and friendly language suitable for social media.” The server then reconstructs the input tokens and passes the modified prompt sentence back to the generative AI model. By repeatedly applying this loop, the server converges to advertising character information that satisfies multiple constraints without requiring human rewriting. This loop changes not only the output text but also the internal token-level patterns seen by the model, which improves the effective utilization of model capacity and reduces the need for manual trial-and-error.

The server constructs advertising information by inserting the validated advertising character information into advertising configuration information. The server uses a template data structure in which individual fields such as title area, main text area, image reference, and call-to-action phrase are represented as distinct elements. The server inserts the advertising character information into the designated field, updates corresponding metadata such as language tag and segment identifier, and generates an advertising object stored in a structured form, for example as a record in a database and a corresponding in-memory representation.

The server transmits the advertising information to an advertising distribution management apparatus. The advertising distribution management apparatus arranges the advertising information into a delivery format suitable for the terminal. The advertising distribution management apparatus selects a specific advertisement for each terminal request based on targeting rules and returns serialized data including the advertising character information to the terminal.

The terminal receives the advertising information via the communication interface. The terminal parses the data and updates its internal view tree or document object model. The terminal uses its GPU-accelerated rendering engine to draw the advertisement on the display. The terminal lays out the advertising character information in a text region according to a style sheet. Because the advertising character information has been constrained in length and format by the server's quality evaluation module, the terminal can render the content without truncation or layout distortion, thereby improving user interface stability and reducing the need for runtime layout recalculations. The user views the displayed advertisement and, if the system is in a review mode, inputs explicit evaluation information or correction request information by operating the terminal. The user can, for example, select options such as “Approve,” “Too long,” or “Tone is too formal,” or the user can directly edit a proposed text in an input field. The terminal sends this evaluation information and correction request information to the server together with identifiers of the related target information and advertising information.

The server receives and stores the evaluation information and correction request information in association with the target information, user information, and the prompt sentence originally used. The server represents this association in a record information structure that may include timestamps, device identifiers, and performance metrics such as click-through events captured later. The server uses these historical data as training-like signals for updating configuration rules of prompt sentences and control conditions for the generative AI model.

The server implements a rule update module that analyzes record information in batch or near real time. The rule update module may apply statistical analysis such as correlation analysis between specific prompt patterns and user behavior information. For example, the server may determine that prompts including phrases like “short and catchy” lead to higher click-through for a certain age segment, while prompts specifying “formal tone” perform worse for the same segment. The server may adjust default templates accordingly, for instance by adding or removing certain instructions for that segment. The rule update module may additionally train a lightweight model that maps context vectors derived from target information and user information to recommended prompt modifiers.

The server then uses this mapping to automatically refine prompt sentences for future generation requests.

By integrating these feedback-driven changes directly into the logic that constructs prompt sentences and configures the generative AI model, the server improves internal computation efficiency. The server reduces the average number of re-generation cycles required to obtain acceptable advertising character information. The server also reduces reliance on manual rule design by human operators, which can otherwise introduce latency and inconsistency. This system-level adaptation is distinct from simple automation of human text writing; rather, the server reconfigures the computational pathway itself, including how text is tokenized, how prompts are structured, and how generation parameters are set, which yields a technical improvement in how the computing apparatus processes language generation tasks.

In another embodiment, the server uses a modular architecture in which the prompt construction module, the generative AI invocation module, the quality evaluation module, the advertising assembly module, and the feedback analysis module are implemented as separate software components. The server may deploy these components in separate processes or containers and communicate between them by message passing or remote procedure calls. This modular design allows the server to parallelize certain operations. For instance, while the generative AI model is generating text for one request, the server can concurrently analyze record information for another request. This concurrency improves throughput and reduces overall response latency experienced by the terminal.

In yet another embodiment, the server uses a caching mechanism to store commonly used prompt fragments and corresponding partial tokenizations. When the server constructs a prompt sentence that includes frequently used instruction segments, the server can reuse pre-computed token sequences instead of re-tokenizing those segments. This reduces CPU cycles spent on tokenization and speeds up the effective rate at which the generative AI model can be invoked. Similarly, the server may maintain a cache of advertising configuration templates and style descriptors, so that inserting new advertising character information requires only minimal template lookup and string replacement operations.

The server can also adjust communication payload sizes by selecting compact representations of advertising information based on terminal characteristics. For example, the server may omit certain optional fields when transmitting advertising information to a low-bandwidth terminal. Because the advertising character information has already been evaluated and normalized with respect to length and content, the server can more reliably estimate the size of each advertisement, which enables more accurate control of communication load and prevents transmission of oversized payloads that could degrade performance on constrained devices.

The system achieves technical effects that go beyond business logic for ad creation. By automatically controlling the structure and parameters of the prompt sentence based on machine-interpretable rules and feedback signals, the server reconfigures the internal operation of the generative AI model in a way that a human writer cannot manually replicate at scale. The server changes token-level input patterns, adjusts decoding conditions, and enforces quality constraints through programmatic loops, leading to improved computational efficiency, reduced error rates in generated advertisements, and more stable rendering on the terminal. These improvements manifest as faster generation, fewer invalid outputs per unit of compute, and decreased need for manual review, which collectively represent an improvement in the underlying computer technology.

In an alternative embodiment, the server incorporates additional feature vectors into the generative AI model input by prefixing or suffixing control tokens that encode attributes such as platform type, placement type, and device class. For example, the server may inject specific tokens that indicate “mobile_banner” or “video_overlay” before the human-readable part of the prompt sentence. This non-conventional use of control tokens allows the generative AI model to specialize its output for different device environments without requiring separate models. As a result, the system reduces memory usage and simplifies deployment because one model instance, configured with different control conditions, can serve multiple contexts.

The terminal may vary depending on implementation. In one variation, the terminal operates as a mobile communication device executing a browser that retrieves advertisements using standard web technologies. In another variation, the terminal operates as a television receiver or digital signage controller that uses a custom client application. In both cases, the terminal relies on the server to supply advertising information that has been structurally adjusted for the terminal's display characteristics, such as resolution and orientation. The server's length and content normalization of advertising character information contributes directly to stable and efficient rendering on different classes of terminals.

The user may interact with the system in different roles. In one role, the user acts as a campaign operator who initiates generation of advertising character information and evaluates outputs before distribution. In another role, the user acts as a consumer whose implicit behavior information, such as click patterns and dwell times, is collected by the terminal and reported to the server. The server integrates both explicit evaluation information and implicit behavior information in the record information structure. The server then uses these recorded interactions to refine the prompt construction rules and model control conditions, thereby closing a technical feedback loop that autonomously improves performance of the computational pipeline over time.

Through these embodiments and variations, the server, the terminal, and the user cooperate to implement a system in which a generative AI model is not used as a simple text generator but as a component in an optimized, feedback-driven computation process. The server controls prompt sentences, tokenization, model parameters, and quality evaluation in a structured and automated manner, which materially improves the functioning of the computer system responsible for generating, delivering, and displaying advertising character information.

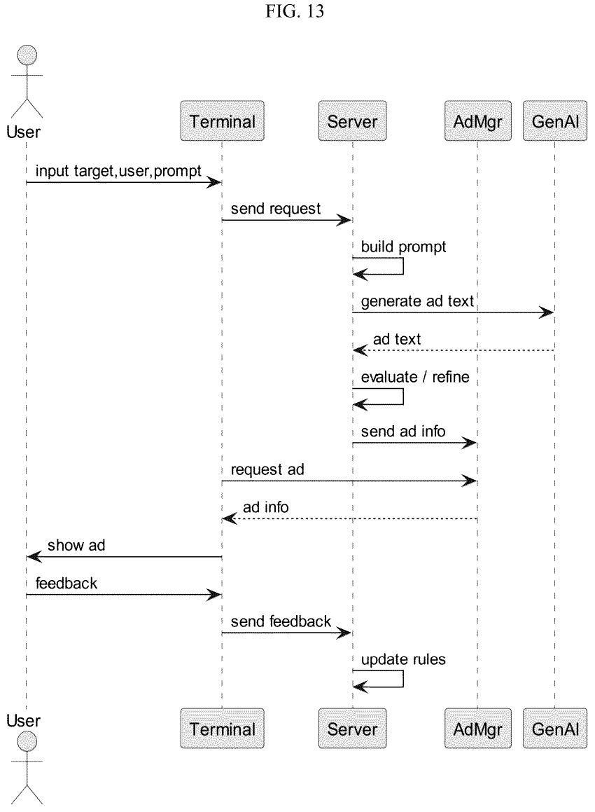

The following describes the processing flow using FIG. 13.

Step 1:

The user operates the terminal to start an advertisement creation interface. The terminal displays a screen including input widgets such as text boxes, drop-down lists, and buttons. The user inputs target information (for example, product name, main feature, category) and user information (for example, target age range, interest category), and then inputs a prompt sentence such as “Please create an ad sentence that emphasizes the features of the new product.” The terminal receives these inputs as character strings and selection values, stores them in local memory as structured objects, and renders them on the display for confirmation. The terminal outputs a request message containing the target information, the user information, and the prompt sentence to the server via a network connection.

Step 2:

The server receives the request message from the terminal through a network interface. The server parses the message, extracts the target information, the user information, and the prompt sentence, and stores them in main memory as structured records. As input, the server uses the raw JSON or similar serialized data received from the terminal. The server performs data parsing and type conversion operations to convert the serialized data into internal data structures, such as dictionaries or objects, and outputs normalized target information and user information ready for further processing.

Step 3:

The server generates context text from the target information and the user information. As input, the server uses the normalized records including fields such as product category, main features, and user segment. The server applies rule-based templates and string concatenation operations to convert each field into a corresponding natural language phrase, for example converting a feature flag into “long battery life” and a segment code into “users in their 20s and 30s who are interested in technology.” The server outputs a context text string that describes the advertising situation in natural language.

Step 4:

The server constructs a final prompt sentence for the generative AI model. As input, the server uses the user-provided prompt sentence and the context text generated in Step 3. The server concatenates a fixed instruction header (for example, “You are a marketing copywriter. Generate a short advertising sentence in English for online use.”), the context text, and the user-provided prompt sentence in a predetermined order. The server may insert separators such as line breaks or special tokens. The server outputs a combined prompt sentence string that encodes both system context and user intent.

Step 5:

The server converts the final prompt sentence into a token sequence suitable for the generative AI model. As input, the server uses the combined prompt sentence string from Step 4. The server invokes a tokenizer that performs character scanning, subword segmentation, and lookup into a token vocabulary to map each subword to an integer token ID. The server outputs an ordered list of integer token IDs representing the prompt sentence, and stores this list in memory as input data for the generative AI model.

Step 6:

The server invokes the generative AI model to generate advertising character information. As input, the server uses the token sequence from Step 5 and model control parameters such as maximum output length, temperature, and sampling thresholds. The server supplies these inputs to the generative AI model, which performs neural network computations including matrix multiplications, attention calculations, and non-linear activations across multiple layers. The model calculates a probability distribution over the next token at each decoding step and the server selects or samples the next token index accordingly. The server iteratively appends selected token indices to an output sequence until a termination condition is met. The server outputs a generated token sequence representing the advertising character information.

Step 7:

The server decodes the generated token sequence into a text string and performs initial normalization. As input, the server uses the generated token indices from Step 6. The server applies a detokenization process that maps each token ID back to its corresponding subword or character representation, concatenates them, and resolves special markers such as spaces and punctuation. The server additionally removes redundant whitespace, corrects basic formatting anomalies, and outputs a raw advertising text string as advertising character information.

Step 8:

The server evaluates the advertising character information with respect to predefined quality criteria. As input, the server uses the advertising text string from Step 7. The server executes a quality evaluation module that performs character counting, word counting, or token counting to compute a length metric, and compares this metric with target thresholds. The server also executes pattern-matching routines and optionally a classification sub-model to detect prohibited expressions or undesired stylistic elements. The server computes evaluation results such as length status (in-range or out-of-range), compliance status (pass or fail), and style score. The server outputs a quality report structure containing these evaluation results.

Step 9:

The server determines whether re-generation of the advertising character information is required and, if needed, modifies the prompt sentence. As input, the server uses the quality report from Step 8 and the original combined prompt sentence from Step 4. When the quality report indicates that one or more criteria are not satisfied, the server adds additional instructions to the prompt sentence, such as “The sentence must be less than 80 characters.” or “Use casual and friendly language suitable for social media users in their 20s.” The server performs string concatenation and insertion operations to produce an updated prompt sentence. If the criteria are satisfied, the server keeps the original text. The server outputs either an updated prompt sentence for re-generation or a confirmation that the current advertising character information is accepted.

Step 10:

The server optionally repeats Steps 5 through 8 using the updated prompt sentence. As input, the server uses the modified prompt sentence from Step 9. The server re-tokenizes the updated prompt sentence, re-invokes the generative AI model with adjusted parameters if necessary, and re-evaluates the new advertising character information. The server continues this loop until the quality report indicates that the advertising character information meets all required criteria. The server outputs a final advertising text string that satisfies length, content, and compliance rules.

Step 11:

The server assembles advertising information by merging the final advertising character information with advertising configuration information. As input, the server uses the final advertising text string from Step 10 and a template structure representing layout and metadata, including fields for title, body text, images, and targeting parameters. The server inserts the advertising text string into the appropriate field of the template, updates relevant metadata fields such as language code and segment identifier, and constructs a complete advertising object. The server outputs structured advertising information ready for distribution.

Step 12:

The server transmits the advertising information to the advertising distribution management apparatus. As input, the server uses the complete advertising object from Step 11. The server serializes the object into a network-compatible format, assigns an advertisement identifier, and sends the serialized data via a network interface using a protocol such as HTTPS. The server may also cache the advertising information in a high-speed storage for future reuse. The server outputs a delivery request containing the advertising information to the advertising distribution management apparatus.

Step 13:

The advertising distribution management apparatus selects the appropriate advertising information for each terminal request and sends it to the terminal. The terminal, as input, receives a response containing the advertising information including the advertising character information. The terminal parses the received data, updates its internal document structure or view hierarchy, and configures visual components such as text labels and image views. The terminal outputs a render-ready representation of the advertisement in memory.

Step 14:

The terminal renders the advertisement and displays it to the user. As input, the terminal uses the render-ready representation from Step 13. The terminal invokes its rendering engine to perform layout calculations, font rasterization, and composition operations, and instructs the display hardware to draw the advertisement, including the advertising character information, on the screen. The terminal outputs a visual display that the user can perceive and interact with.

Step 15:

The user reviews the displayed advertisement and, if permitted, provides evaluation information or correction request information. As input, the user observes the text and layout and decides whether the content meets the intended requirements. The user operates the terminal, for example by pressing an “Approve” button, selecting “Too long” or “Tone is too formal,” or editing the text directly in an input field. The terminal captures these interactions as structured feedback data. The terminal outputs the evaluation information and correction request information to the server.

Step 16:

The server receives and stores the evaluation information and correction request information as record information. As input, the server uses the feedback data from Step 15 together with identifiers of the corresponding target information, user information, and prompt sentence used in generation. The server writes a record to a persistent storage system, associating the feedback with the original generation context. The server also may compute derived metrics such as approval rate or revision frequency. The server outputs updated record information that accumulates multiple feedback events over time.

Step 17:

The server analyzes the accumulated record information to update configuration rules of prompt sentences and control conditions for the generative AI model. As input, the server uses a collection of record information entries including prompt variations, evaluation outcomes, user behavior information (such as click-throughs), and performance indicators. The server executes analysis algorithms such as statistical aggregation, correlation analysis, or lightweight machine learning to identify patterns linking specific prompt constructions or model parameters with superior performance. The server then modifies stored configuration rules, for example by increasing the frequency of including certain instruction phrases for particular segments or by adjusting default output length limits and sampling parameters. The server outputs updated rule sets and parameter configurations that will be used in future executions of Steps 3 through 6, thereby refining the behavior of the generative AI model and improving technical performance of the overall system.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented advertising systems generally apply static business rules or simple heuristics to select advertisement text based on coarse audience segments. In such systems, a processor typically retrieves preauthored text variants from storage and chooses one variant according to basic conditions, such as broad demographic categories or keyword matches. As a result, the system architecture and processing pipeline are not designed to dynamically synthesize and evolve advertisement text in response to fine-grained, time-varying user states, including detailed behavior histories and emotion signals. This leads to several technical problems.

First, existing systems lack an integrated mechanism in which a processor automatically constructs machine-oriented prompt sentences from heterogeneous input signals and supplies those prompt sentences to a generative AI model in a closed loop. In many environments, any use of generative models is ad hoc: instructions to the model are handcrafted by human operators or fixed in static templates, and there is no programmable feedback path from runtime performance data back into the prompt-generation logic. Consequently, the processor cannot adapt its prompt construction and model invocation behavior at scale, and the overall computing system is unable to evolve its generation strategy in response to observed system-level performance.

Second, conventional systems typically treat user behavior logs, such as search histories and browsing histories, and user emotion information, such as sentiment or affect inferred from sensor data, as separate analytics streams that are not tightly coupled to the runtime text generation pipeline. Even when behavior and emotion analytics are available, the main request-response path between a client device and a server often uses only a subset of this information, and the processor does not synthesize a unified user state representation that can be consumed directly by a generative AI model. This disjoint design limits the ability of the computing system to generate context-appropriate text in real time, and forces developers to hard-code ad-hoc rules, which degrades maintainability and scalability of the software architecture.

Third, conventional systems have only limited capability to automatically optimize the generation behavior of generative AI models based on measured advertisement performance, such as impression data, click data, and conversion data. In existing architectures, performance metrics are often used merely for offline reporting, without being fed back as control signals that affect how prompt sentences are generated and how models are invoked. As a result, the processor cannot programmatically discover high-performing patterns of prompts or generated text and cannot automatically update its own generation rules. This static behavior leads to suboptimal utilization of computing resources and generative AI capabilities, and does not improve the internal operation of the computing system.

Accordingly, there is a need for an improved computer-implemented system and method in which a processor (i) acquires and fuses merchandise characteristic information, user attribute information, user behavior information, and user emotion information into user state information, (ii) automatically generates, updates, and supplies prompt sentences to a generative AI model based on that user state information, and (iii) collects display and operation information for generated advertisement content and automatically updates prompt-generation rules in response. By restructuring the data flow and control flow inside the server, such a system should improve the technical operation of the computer itself, including dynamic text generation, real-time personalization, and adaptive optimization of prompt generation without human intervention.

The specific processing by the specific processing unit 290 of the data processing device 12 in Application Example 2 is realized by the following means.

The present invention provides a server comprising a processor configured to acquire merchandise characteristic information and user attribute information from one or more client devices or storage units; to analyze user behavior information and user emotion information in addition to the merchandise characteristic information and the user attribute information so as to generate user state information representing a current state of a user or a user segment; to generate, on the basis of the merchandise characteristic information, the user attribute information, and the user state information, a machine-interpretable prompt sentence to be input to a generative information processing model; to cause the generative information processing model to automatically generate asset text by inputting the prompt sentence to the generative information processing model; to generate advertisement content information by inserting the asset text into advertisement template information; to transmit the advertisement content information to an output apparatus and cause the advertisement content information to be displayed on the output apparatus; and to collect display information and operation information relating to the advertisement content information and update generation rules of the prompt sentence used for generation of the asset text. This enables the computing system to internally transform heterogeneous input signals into structured user state information, to automatically synthesize and refine prompt sentences supplied to a generative AI model, and to adapt the model-driven text generation pipeline in real time based on observed performance, thereby improving the technical functioning of the server and achieving more efficient and responsive generation, delivery, and optimization of advertisement text.

The term “merchandise characteristic information” refers to information representing properties of an item or service to be advertised, including at least one of a category, a price range, a specification, a performance attribute, a target segment, or another descriptive attribute of the item or service.

The term “user attribute information” refers to information representing characteristics of a user or a user group, including at least one of an age range, a gender, an interest category, a preference, a location, or a purchase history.

The term “user behavior information” refers to information representing actions performed by a user in an information environment, including at least one of a search history, a browsing history, a page-view history, a click history, or a dwell-time history.

The term “user emotion information” refers to information representing an estimated emotional state of a user, the emotional state being derived from at least one of sensor data, textual input, voice input, or interaction patterns, and indicating, for example, joy, satisfaction, dissatisfaction, anger, or another affective state.

The term “user state information” refers to information that is generated by analyzing at least the merchandise characteristic information, the user attribute information, the user behavior information, and the user emotion information, and that represents a synthesized state of a user or a user segment used for controlling text generation.

The term “prompt sentence” refers to a machine-interpretable natural-language or structured-text instruction that is generated by the processor on the basis of at least the merchandise characteristic information, the user attribute information, and the user state information, and that is supplied as input to a generative information processing model to control generation of asset text.

The term “generative information processing model” refers to a machine-implemented model that performs probabilistic or statistical information processing to generate text data or other content data in response to an input prompt sentence.

The term “asset text” refers to text data generated by the generative information processing model, the text data being usable as at least a part of advertisement text information within advertisement content information.

The term “advertisement template information” refers to data defining a structure or layout of advertisement content, the data including at least one placeholder for asset text and optionally including placeholders for other elements such as images, control elements, or style parameters.

The term “advertisement content information” refers to data representing a concrete advertisement instance generated by inserting asset text into advertisement template information, the data being suitable for rendering on an output apparatus.

The term “output apparatus” refers to a device configured to present advertisement content information to a user, including at least one of a display device, a terminal device, or another presentation device capable of outputting visual, auditory, or combined content.

The term “display information” refers to information indicative of how advertisement content information has been presented on an output apparatus, including at least one of an impression event, a display duration, a position, or a rendering context.

The term “operation information” refers to information indicative of user interactions with advertisement content information, including at least one of a click event, a touch event, a selection event, a scroll operation, or a conversion event.

The term “generation rules of the prompt sentence” refers to control data or procedures used by the processor to construct the prompt sentence from at least the merchandise characteristic information, the user attribute information, the user behavior information, and the user emotion information, the control data or procedures defining a structure, a content selection policy, or a style of the prompt sentence.

The term “performance evaluation information” refers to information obtained by analyzing at least the display information and the operation information, the information indicating performance of advertisement content, such as a click-through rate, a conversion rate, or another effectiveness metric.

The term “pattern of the prompt sentence or the asset text” refers to a recurrent combination of structural or semantic features of a prompt sentence or asset text, the combination being identified by analyzing performance evaluation information as yielding relatively favorable performance.

In one embodiment, a server cooperates with one or more terminals operated by one or more users to implement the claimed system. The server includes at least one processor, a main memory, a non-volatile storage device, and a network interface. The terminals include, for example, a smartphone, a tablet, or a personal computer equipped with a display, an input interface, a camera, a microphone, and a communication interface. The server executes software modules that implement acquisition of merchandise characteristic information and user attribute information, analysis of user behavior information and user emotion information, generation of user state information, generation of a prompt sentence, invocation of a generative AI model, generation of asset text, construction of advertisement content information, transmission and display of the advertisement content information, and feedback-based updating of prompt-generation rules.

The server stores data in a structured data management system, such as a relational database management system. The server manages at least a merchandise table, a user attribute table, a user behavior table, a user emotion table, a user state table, a prompt history table, a generated text log table, and a performance evaluation table. Each table has defined fields that enable efficient indexing and retrieval. For example, the user behavior table includes a user identifier field, a timestamp field, an event type field, a resource identifier field, and a dwell time field. The user emotion table includes a user identifier field, a timestamp field, an emotion label field, and a confidence score field. The user state table includes a user identifier field, a segment identifier field, an interest vector field, and an emotion vector field. The prompt history table includes a prompt identifier field, a campaign identifier field, a prompt text field, and a rule identifier field.

The server acquires merchandise characteristic information and user attribute information from terminals and from local or remote storage. The server receives, via a network interface, user input representing merchandise characteristics such as product category, approximate price range, feature descriptors, and intended target segment. The server also receives user attribute information such as age range, gender, interest categories, and location region. The server stores this information as normalized entries in the merchandise table and the user attribute table. The server uses input-validation logic to ensure that fields are consistent with pre-defined schemas. This normalization allows the server to perform indexed queries and vectorization operations in a deterministic and efficient manner, which improves overall processing speed compared with unstructured storage.

The terminal collects user behavior information and user emotion information and transmits these data to the server. The terminal executes a tracking script in a browser or application framework to monitor user actions, including search queries, page views, scroll events, click events, and conversion events. The terminal associates each event with a user identifier or session identifier and transmits event records to the server using a compact, batched communication protocol to reduce network overhead. The terminal also acquires sensor data from the camera and the microphone and forwards audio-visual frames to an emotion-estimation module, which can be executed locally or on the server. When the emotion-estimation module is executed remotely, the terminal sends compressed image and audio features instead of raw streams to reduce communication load.

The server analyzes user behavior information and user emotion information to generate user state information. The server periodically reads batches of records from the user behavior table and converts them into feature vectors using a feature-extraction module implemented, for example, in an interpreted language runtime with a numerical computation library. The server encodes search terms into term-frequency or embedding vectors, encodes visited resources into categorical indices, and encodes sequence patterns into aggregated statistics such as counts and recency scores. The server also processes user emotion information to generate emotion vectors, for example, by mapping discrete emotion labels and confidence scores into a low-dimensional, real-valued representation. The server then combines merchandise characteristic information, user attribute information, behavior feature vectors, and emotion vectors to produce user state information. The user state information is stored as a structured vector representation in the user state table. This explicit representation of user state allows the processor to reuse and update state without recomputing all raw analytics, which reduces computational cost and latency.

The server generates a prompt sentence for a generative AI model by applying rule-based and learned transformations to the user state information. The server maintains a prompt-rule module that encodes mapping rules from structured features in the user state information to natural-language clauses. For example, if the user state information indicates that a user frequently searches for luxury items and exhibits a positive emotion vector, the server composes a clause describing the user as “interested in high-end products and currently feeling positive.” The server concatenates such clauses with merchandise characteristic information and user attribute information to form a complete prompt sentence. The server also maintains rule parameters that control the structure and style of the prompt sentence, such as whether to request a short or long output, whether to emphasize price or features, and which tone (formal or casual) to request. The prompt-rule module differs from general, manually written templates in that it uses user state vectors and performance feedback to alter the composition and weighting of clauses. This results in dynamic prompt sentences that would be difficult to construct reliably by ad-hoc manual editing.

The server can also accept prompt sentences provided directly by users and can augment these prompt sentences with additional clauses derived from user state information. For example, the user may enter a prompt sentence on the terminal such as:

“Generate a catchy copy that highlights the latest smartphone's features.”

The server receives this user-authored prompt sentence and adds contextual clauses such as “The target users are males in their 20s who are interested in technology and currently feel excited.” The server appends further instructions, for example “Generate a single sentence under 80 characters in length with an enthusiastic tone.” The unified prompt sentence is then supplied to the generative AI model. In another example, the server constructs a prompt sentence autonomously, such as:

“The user searched for ‘luxury watches’. Based on this information, please generate a related advertisement sentence.”

In still another example, the server constructs an emotion-oriented prompt sentence such as:

“The user is dissatisfied with recent service. Generate an advertisement message that acknowledges the dissatisfaction and explains efforts to improve service.”

The server invokes a generative AI model implemented as a trained neural network. In one embodiment, the generative AI model is a transformer-based language model including a stack of self-attention layers, feedforward layers, and normalization layers. The model is trained in advance on a large corpus of text using an autoregressive training objective that minimizes a cross-entropy loss between predicted token distributions and observed next tokens. During training, the model updates weight parameters using gradient-based optimization such as stochastic gradient descent with adaptive learning-rate control. The training process can use data augmentation strategies, for example, random masking of tokens, mixing of domain-specific corpora, or perturbation of sentence structures to improve generalization. The model thus learns a mapping from prompt sentences to output text sequences.

The server supplies the prompt sentence as a token sequence to the generative AI model and configures model parameters such as maximum output length, sampling temperature, and top-k or top-p sampling thresholds. By controlling such parameters, the server can adjust the diversity and determinism of the generated asset text. The server receives generated tokens from the model and converts them back into a textual asset. The server logs the generated asset text and the corresponding prompt sentence in the generated text log table, together with identifiers for the user state and the current prompt-rule version. This logging enables subsequent analysis of how different prompt-rule configurations affect output quality and performance.

The server generates advertisement content information by combining the generated asset text with advertisement template information. The server selects a template based on device type, display format, and campaign configuration. The template can be represented as a markup structure with placeholders for a headline, a description, a call-to-action text, and additional metadata, such as style and layout parameters. The server inserts the generated asset text into a headline or description placeholder and fills other placeholders with merchandise characteristic information, such as a product name and a price range. The resulting advertisement content information is then serialized into a data structure suitable for transmission to a terminal. Because the server generates advertisement content by programmatically inserting asset text into predefined templates, the server can guarantee compliance with presentation constraints such as maximum text length for different display types, and can handle multiple form factors with limited additional computation.

The server transmits advertisement content information to the terminal via the network interface. The terminal receives the advertisement content information and renders the advertisement on the display. The terminal executes rendering logic that takes into account the screen size and orientation, and applies platform-specific styling. The terminal displays the asset text in designated visual regions, such as a banner area or an in-feed card. By doing so, the system interlinks the server's internal text-generation pipeline with an actual output apparatus rather than stopping at abstract data processing. The rendered advertisement content constitutes a concrete control of how pixels are driven on a hardware display and affects subsequent user behavior, which the system records again as data.

The server collects display information and operation information relating to the advertisement content. The server receives signals from the terminal indicating impression events, click events, and conversion events. The server also receives metadata such as time of display, placement position, and device type. The server stores this information in the performance evaluation table and associates each record with identifiers of the prompt sentence and the generated asset text that were used for the corresponding advertisement. The server computes performance metrics such as click-through rates and conversion rates for combinations of user state patterns and prompt-rule versions. The server then uses these metrics to update prompt-generation rules.

The server updates generation rules of the prompt sentence by analyzing correlations between features of prompts or asset texts and performance evaluation information. In one embodiment, the server extracts patterns from the prompt history table and the generated text log table by representing each prompt sentence and asset text as a feature vector. The feature vector can include, for example, counts of certain instruction phrases, indicators of whether price is mentioned early, text length, sentiment polarity, or whether an emotion label was explicitly referenced. The server trains a secondary model, such as a logistic regression classifier or a shallow neural network, to predict performance outcomes from these features. The server then updates parameters of the prompt-rule module to favor clause combinations and styles that historically yield better performance for particular user state configurations. Because this process is automated and based on model-driven inference, the server can adjust its prompt construction logic in ways that are not intuitive for human operators, thereby improving throughput and text quality at scale.

The server, by structuring data and using a generative AI model in this particular pipeline, achieves technical effects beyond mere automation of human copywriting. The server reduces network traffic by representing user state as compact vectors and transmitting only identifiers and summary statistics between modules, instead of repeatedly transmitting raw logs and full histories. The server reduces processing latency by caching user state vectors and reusing them across multiple generation requests, avoiding redundant analysis. The server improves generation accuracy and relevance by using a fine-grained integration of behavior and emotion features into prompt sentences, which cannot be feasibly replicated by simple rule-based selection of prewritten text. The server also improves resource utilization by adapting sampling parameters and prompt structures according to performance feedback, which reduces the number of low-quality generations and the need for repeated calls to the generative AI model.

The server implements decision logic and rule-updating logic that differ from conventional human workflows. In a human workflow, a copywriter manually inspects analytics reports and updates text or templates in discrete cycles. In contrast, the server defines an internal control loop in which user state vectors, prompt sentences, generated asset texts, and performance metrics form linked data structures fed into machine-learning algorithms. These algorithms automatically adjust rule parameters that determine how future prompts are assembled. The server thereby executes a non-conventional sequence of operations-state vector generation, prompt feature analysis, rule parameter adjustment, and generative model invocation-that collectively improves the behavior of the computing system and reduces human intervention.

The server can be implemented with alternative generative AI models and alternative state representations. In one alternative embodiment, the server uses a sequence-to-sequence language model with encoder-decoder architecture instead of a purely autoregressive transformer. In another embodiment, the server compresses user state information into a fixed-length embedding using a separate neural network trained on historical behavior and emotion sequences, and then passes that embedding as part of the input to the generative AI model. In another variation, the server uses reinforcement-learning-based tuning to adjust prompt-rule parameters, where the reward is derived from measured click-through rates and conversion rates. These alternative architectures still maintain the core functions of constructing prompt sentences from heterogeneous inputs, invoking a generative AI model, and updating prompt-generation rules based on performance.

The terminal may implement different sensing and rendering configurations. In one embodiment, the terminal executes an emotion-recognition module locally, using a convolutional neural network for facial expression recognition and a recurrent neural network for voice prosody analysis. In another embodiment, the terminal offloads emotion recognition entirely to the server and only performs lightweight pre-processing such as face detection or voice activity detection to reduce data volume. The terminal can also pre-cache advertisement templates and style resources, allowing the server to send only text updates and small control payloads when asset texts are regenerated, which reduces bandwidth usage and improves responsiveness.

The user interacts with the system mainly through the terminal interfaces, and the system does not rely on human operators to change configurations manually after deployment. The user may provide high-level instructions for certain campaigns, for example:

“For men aged 18-24 who are interested in running, generate an advertisement for new sports shoes, focusing on performance and modern design.”

The server processes this instruction, maps referenced attributes to internal state features, and constructs a precise prompt sentence that respects internal constraints and optimization strategies. The resulting advertisement text is thus generated and optimized according to machine-interpretable rules that integrate behavioral and emotional context, rather than according to ad-hoc manual edits. The described embodiments illustrate that the system is not limited to abstract data manipulation but is tied to specific hardware components and produces concrete technical effects. The server controls generation of display content tailored to measured, fine-grained user states and optimizes its own internal algorithms using performance feedback. This architecture improves processing efficiency, reduces error rates in content selection, and lowers communication overhead, thereby enhancing the technical operation of the computer system as a whole.

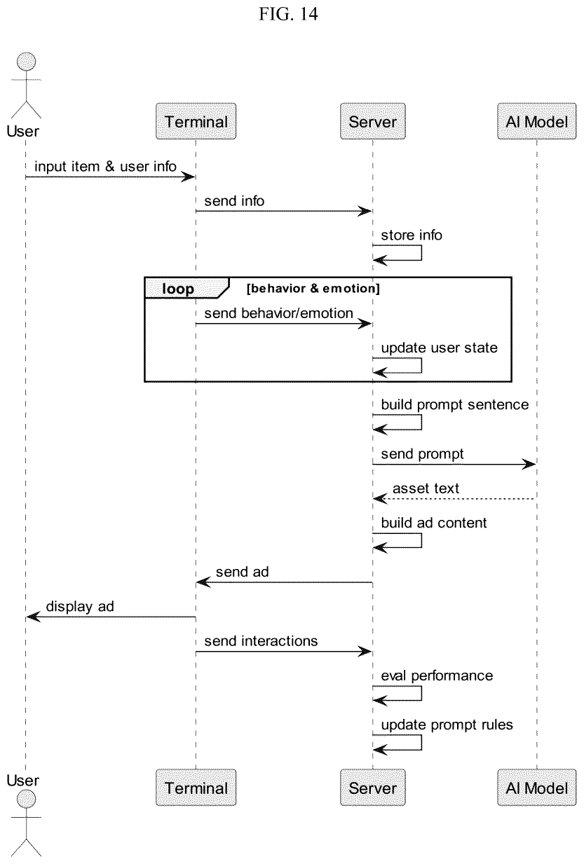

The following describes the processing flow using FIG. 14.

Step 1:

User operates the terminal to input merchandise characteristic information and user attribute information.

User enters values such as product category, feature description, approximate price range, and target audience characteristics (for example, age range and interest categories) into input fields on a graphical user interface.

Input: raw text and selection values typed or selected by the user on the terminal.

Terminal validates required fields, converts selections into internal codes (for example, numeric identifiers for categories and interests), and packs these values into a structured request.

Output: a structured data payload containing normalized merchandise characteristic information and user attribute information, which the terminal sends to the server over a network connection.

Step 2:

Server receives and stores the merchandise characteristic information and the user attribute information.

Server accepts the structured payload from the terminal through an application programming interface, parses the fields, and maps them to predefined database columns.

Input: the structured merchandise characteristic information and user attribute information received from the terminal.

Server writes the parsed values into corresponding records in data tables (for example, a merchandise table and a user attribute table) using a database management system, and assigns identifiers such as product IDs and audience IDs.

Output: persistent database records that can be retrieved by identifier for later processing, and an acknowledgment message sent back to the terminal.

Step 3:

Terminal collects user behavior information during interactions with content.

Terminal executes tracking logic to record events such as search queries entered by the user, page views, scroll positions, click events on interactive elements, and the duration that pages remain visible on the display.

Input: low-level event data generated by the operating system and application framework when the user interacts with the terminal (for example, key presses, touch events, and navigation actions).

Terminal aggregates these low-level events into higher-level behavior records, assigns timestamps and user or session identifiers, and filters noise such as rapid repeated clicks.

Output: compact behavior records representing user behavior information, transmitted periodically or in batches to the server.

Step 4:

Server receives and logs user behavior information.

Server reads the incoming behavior batches from the terminal, decodes each event record, and stores them in a user behavior table with indexed fields for efficient querying.

Input: batched user behavior information including event types, resource identifiers, timestamps, and identifiers associated with users or sessions.

Server performs consistency checks (for example, discarding events with invalid timestamps), assigns or verifies user identifiers, and inserts the cleaned records into persistent storage.

Output: a time-ordered log of user behavior information per user, stored in the database and ready for analytical processing.

Step 5:

Terminal acquires user emotion information from sensors and sends it to the server.

Terminal activates a camera and a microphone according to user consent, captures video frames and audio segments while the user is viewing content or advertisements, and executes pre-processing routines such as down-sampling and feature extraction.

Input: raw sensor signals including image sequences and audio waveforms.

Terminal converts the raw signals into feature sets suitable for emotion estimation, such as facial landmark coordinates, spectral features, or prosodic features, and then packages these features with timestamps and user identifiers.

Output: pre-processed sensor feature data representing potential user emotion information, transmitted to the server or to an associated emotion-recognition service.

Step 6:

Server (or an associated emotion-recognition component) generates user emotion information from sensor data.

Server receives the sensor feature data from the terminal and applies trained classification logic to infer emotion labels and confidence scores.

Input: feature vectors extracted from video and audio (for example, facial expression vectors and voice prosody vectors) with associated timestamps.

Server feeds these feature vectors into an emotion-classification model, such as a neural network with convolutional layers for image features and recurrent or attention layers for temporal patterns, and computes probabilities for discrete emotion categories.

Output: user emotion information consisting of emotion labels (for example, joy, dissatisfaction, or anger) and associated confidence scores, stored in a user emotion table with user identifiers and timestamps.

Step 7:

Server generates user state information by analyzing user behavior information and user emotion information together with merchandise characteristic information and user attribute information.

Server retrieves relevant records from the merchandise table, user attribute table, user behavior table, and user emotion table for a given user or audience and converts these records into numerical feature representations.

Input: stored merchandise characteristic information, user attribute information, user behavior logs, and user emotion logs.

Server computes aggregated behavior vectors (for example, counts and recency scores of visited categories or searched keywords) and emotion vectors (for example, average and recent distribution of emotion labels), and then concatenates or transforms these vectors into a single user state vector using mathematical operations such as normalization, weighting, and dimensionality reduction.

Output: user state information stored as structured vectors in a user state table, representing current interests and emotional tendencies of users or segments.

Step 8:

Server generates a prompt sentence for a generative AI model based on the user state information, the merchandise characteristic information, and the user attribute information.

Server invokes a prompt-construction module that maps structured fields and user state vectors to human-readable clauses and assembles them into a coherent instruction.

Input: user state information (including interest and emotion vectors), merchandise characteristic information (such as product type and price range), and user attribute information (such as age range and interest categories), and optionally a user-authored partial prompt.

Server applies rule sets and parameterized templates to determine which clauses to include, how to describe the user and merchandise, and what constraints to impose on length and tone; the module then concatenates these clauses into a natural-language prompt sentence, such as “The user searched for ‘luxury watches’. Based on this information, please generate a related advertisement sentence.”

Output: a complete prompt sentence that is stored in a prompt history structure and passed to the generative AI model.

Step 9:

Server invokes the generative AI model using the prompt sentence and obtains asset text.

Server converts the prompt sentence into a token sequence, configures model inference parameters (for example, maximum output length, sampling strategy, and temperature), and forwards the token sequence to the generative AI model running locally or on an external computation resource.

Input: the generated prompt sentence and model configuration parameters.

The generative AI model, which is a trained neural network comprising multiple attention layers and feed-forward layers, processes the token sequence, computes context-dependent token probabilities, and iteratively selects output tokens until an end-of-sequence condition is reached; the server then decodes the resulting token sequence into text.

Output: asset text, which is an advertisement text candidate generated by the generative AI model in response to the prompt sentence, and a log record containing the mapping between the prompt and the generated text.

Step 10:

Server post-processes and optimizes the asset text according to system constraints and audience characteristics.

Server evaluates the asset text using deterministic checks and learned filters to confirm that the text satisfies constraints on length, wording, and style for a particular placement.

Input: the raw asset text generated by the generative AI model and configuration data describing allowed length ranges, prohibited terms, and stylistic preferences for the target audience.

Server measures the character count and token count, searches for disallowed phrases, and optionally uses an auxiliary classifier to score tone appropriateness; if the asset text violates constraints, the server modifies the prompt sentence by adding explicit instructions (for example, “Shorten the following ad to under 60 characters while keeping its meaning”) and regenerates the text, or applies deterministic truncation or rewriting rules.

Output: optimized asset text that satisfies system constraints and is associated with metadata specifying its intended use context.

Step 11:

Server constructs advertisement content information by inserting the optimized asset text into advertisement template information.

Server selects an appropriate template based on the selected advertisement placement type, such as a banner, an in-feed card, or an interstitial, and loads the corresponding structure containing placeholders for text and other elements.

Input: optimized asset text, merchandise characteristic information (for example, product name and price), and advertisement template information defining layout and style.

Server replaces designated placeholders with the asset text and other contextual values, sets layout parameters such as font size and line breaks according to device class, and generates a complete representation of advertisement content information that can be directly rendered by a terminal.

Output: structured advertisement content information containing text and layout data, prepared for transmission to an output apparatus.

Step 12:

Server transmits the advertisement content information to the terminal and causes it to be displayed.

Server sends the advertisement content information through the network interface in response to a content request or as part of a scheduled delivery, and includes identifiers for tracking performance.

Input: advertisement content information and addressing information indicating the destination terminal.

Terminal receives the advertisement content information, decodes the layout and text fields, and uses a rendering engine to draw the advertisement on the display at a specific position, for example, at the top of a content feed or inside a designated advertisement area.

Output: visual representation of the advertisement on the terminal's display, where pixels are driven according to the advertisement content information, and a record on the server side indicating that an impression event occurred.

Step 13:

Terminal records user interactions with the displayed advertisement as operation information and sends this information to the server.

Terminal monitors user actions on the advertisement, such as taps, clicks, swipes, or dismissals, and captures resulting navigation events such as transitions to landing pages or completion of purchase flows.

Input: low-level input events and navigation state changes detected by the terminal's operating system and application framework while the advertisement is visible.

Terminal aggregates these events into operation records containing event types, timestamps, advertisement identifiers, and optional additional data (for example, pointer coordinates), and periodically transmits these records to the server.

Output: user operation information related to the advertisement content information, delivered to the server for analysis.

Step 14:

Server generates performance evaluation information from display information and operation information.

Server reads impression logs and operation logs for each advertisement variant, joins them with prompt history and asset text logs, and computes performance metrics.

Input: display information (such as impression counts and display durations), operation information (such as click events and conversion events), and identifiers linking each display to a specific prompt sentence and asset text.

Server applies aggregation functions to calculate metrics such as click-through rates and conversion rates per prompt pattern, per user state pattern, and per merchandise group; server stores these metrics as performance evaluation information in a dedicated table, which is indexed by prompt and asset identifiers.

Output: performance evaluation information that quantitatively describes the effectiveness of different prompt sentences and asset texts under different conditions.

Step 15:

Server updates generation rules for future prompt sentences based on the performance evaluation information.

Server analyzes feature patterns in prompt sentences and asset texts that correlate with favorable metrics, and adjusts rule parameters in the prompt-construction module.

Input: performance evaluation information, prompt sentences stored in the prompt history, and associated asset texts from the generated text log.

Server encodes each prompt and asset text as a feature vector (for example, by counting instruction phrases, sentiment indicators, and structural markers), trains or updates a predictive model that learns relationships between these features and observed performance, and then modifies internal rule weights that determine which clauses and instructions are preferred during prompt generation for particular user state configurations.

Output: updated generation rules of the prompt sentence that influence future calls to the generative AI model, resulting in prompt sentences that are more likely to produce high-performing asset text for given user states.

Step 16:

Server regenerates user state information and advertisement content information in response to changes in user behavior information and user emotion information.

Server monitors incoming behavior and emotion records, detects significant changes such as newly searched keywords or a shift from a positive to a negative emotion label, and triggers recomputation of user state vectors.

Input: new user behavior logs and new user emotion logs received after an advertisement has been initially configured or displayed.

Server recalculates behavior and emotion features, updates the corresponding user state information in the user state table, generates a new prompt sentence reflecting the updated state, invokes the generative AI model to obtain new asset text, and reconstructs advertisement content information with the updated text.

Output: refreshed user state information and updated advertisement content information, enabling the terminal to display advertisements that remain aligned with the latest user behavior and emotion.

Step 17:

Terminal receives updated advertisement content information and replaces previously displayed text where applicable.

Terminal listens for push updates or periodically requests updated advertisement payloads from the server, identifies that a newer version of advertisement content information is available for a currently visible placement, and retrieves it.

Input: updated advertisement content information associated with existing advertisement identifiers.

Terminal replaces the text elements of the on-screen advertisement with the newly provided asset text while preserving layout constraints and visual continuity, so that the user sees an advertisement that reflects the most current state.

Output: a dynamically updated advertisement display on the terminal that presents new asset text generated from the latest user state, without requiring the user to reload the entire application or page.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

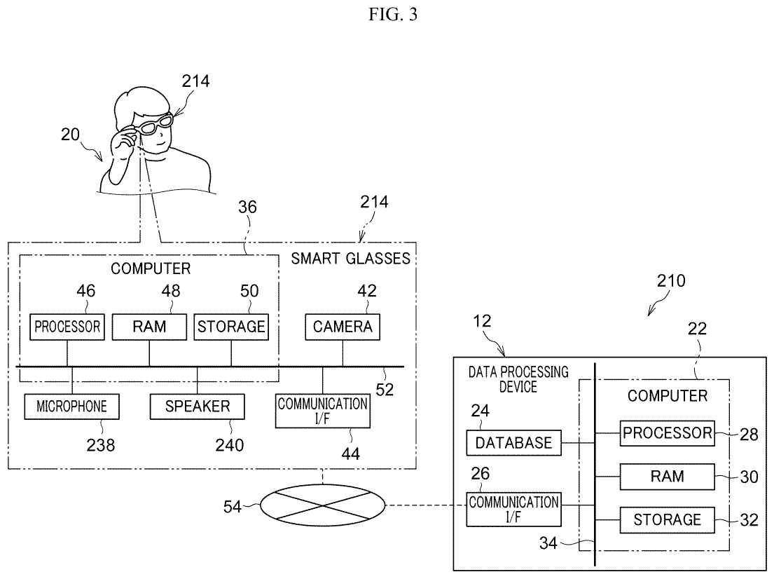

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

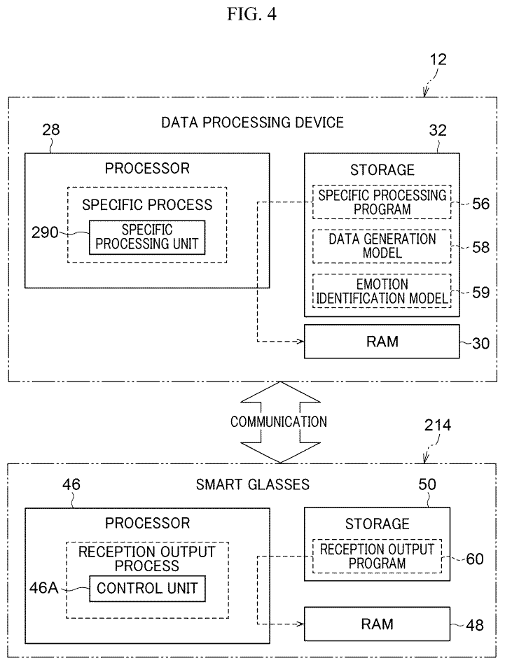

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

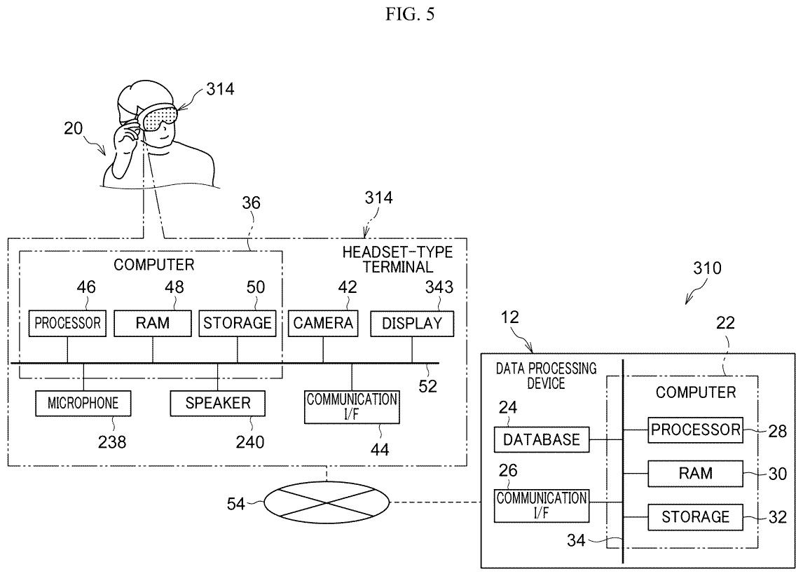

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

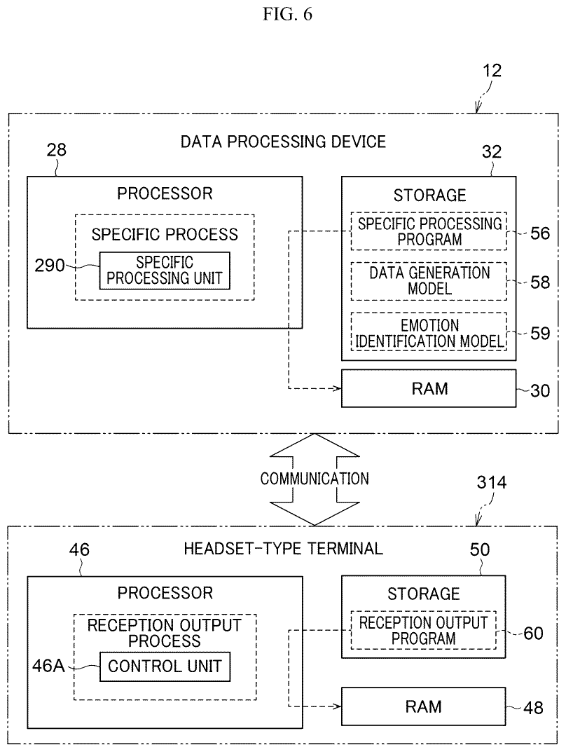

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

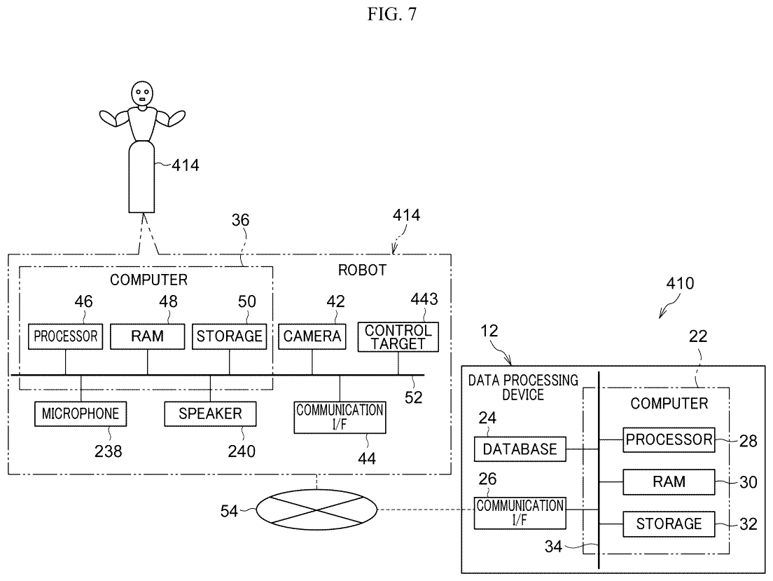

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

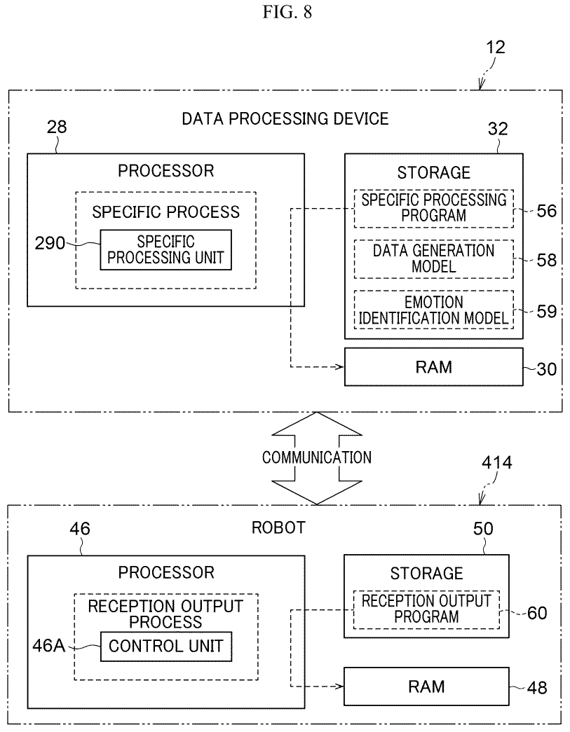

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

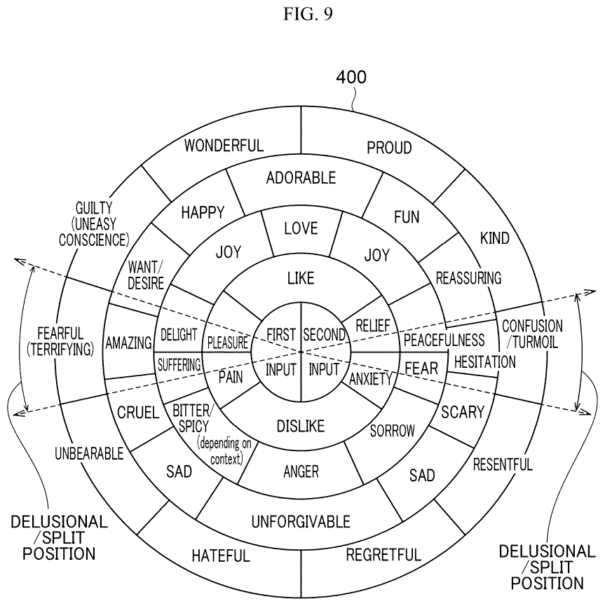

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

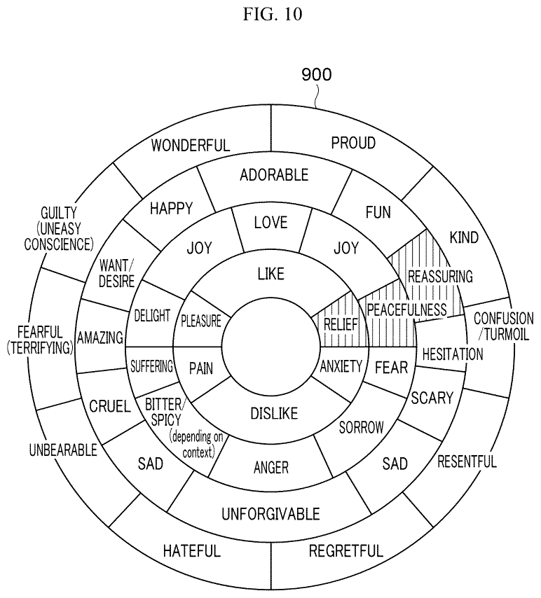

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

receive, from a terminal, item information relating to a merchandise and user information relating to a user; and

store the received item information and user information as structured information and perform normalization and preprocessing on the structured information; and

generate, based on the preprocessed structured information, a prompt sentence suitable for a generative AI model by assembling an instruction sentence for input to a language generation apparatus using a template; and

transmit the generated prompt sentence to an external language generation apparatus and acquire, from the language generation apparatus, an asset sentence which is advertisement text corresponding to the prompt sentence; and

determine whether the acquired asset sentence satisfies length constraints, expression constraints, and inappropriate-expression constraints, and in response to the asset sentence not satisfying at least one of the constraints, perform at least one of re-requesting generation from the language generation apparatus and executing a correction process on the asset sentence; and

associate the asset sentence with advertisement configuration information, store the associated information, and generate advertisement information for advertisement distribution; and transmit the advertisement information to a terminal or a distribution apparatus and cause an advertisement including the asset sentence to be displayed.

### (Supplementary 2)

The system according to supplementary 1,

wherein the processor is configured to

aggregate history information based on user behavior history as part of the item information and the user information, generate feature information by summarizing the history information, and incorporate the feature information into the prompt sentence so as to optimize the asset sentence.

### (Supplementary 3)

The system according to supplementary 1,

wherein the processor is configured to

sequentially receive updated user attribute information and user behavior information from the terminal, regenerate the prompt sentence and the asset sentence based on the updated information, and update the advertisement configuration information in real time.

### Application Example 1

### (Supplementary 1)

A system comprising a processor,

wherein the processor is configured to

acquire user information including at least attribute information and behavior information from a storage unit or a terminal device and to preprocess the user information including complementing missing values, normalizing numerical values, and encoding categorical values,

acquire product information including at least category information, price information, and target segment information from a storage unit and to preprocess the product information including encoding category information and scaling price information,

generate a prompt sentence that describes a relationship between a user and a product, on a basis of the preprocessed user information and the preprocessed product information, the prompt sentence including at least a description of user attributes and user behavior and a description of characteristics of a product to be advertised,

input the generated prompt sentence into a generative AI model implemented by a machine learning framework, and automatically generate an advertising asset sentence corresponding to the prompt sentence,

perform a validation process on the generated advertising asset sentence, the validation process including at least checking compliance with a length constraint, checking compliance with an expression constraint, and determining presence or absence of a prohibited term, and generate a validated advertising asset sentence,

generate advertising information including at least the validated advertising asset sentence, product identification information corresponding to the validated advertising asset sentence, and display control information, and transmit the advertising information to the terminal device in response to an advertising request from the terminal device in real time,

acquire behavior history information from the terminal device, the behavior history information including at least an advertisement display history, an advertisement selection history, and a purchase history associated with the advertising information, and store the behavior history information as learning data for updating the user information and the product information, and update at least one of a processing condition for generating the prompt sentence and automatically generating the advertising asset sentence and a learning state of the generative AI model, on a basis of the stored behavior history information.

### (Supplementary 2)

The system according to supplementary 1,

wherein the processor is configured to select or regenerate, in real time, the advertising asset sentence on a basis of the attribute information included in the user information and the behavior history information acquired from the terminal device, and to retransmit the selected or regenerated advertising asset sentence to the terminal device so as to dynamically update an advertisement displayed on the terminal device.

### (Supplementary 3)

The system according to supplementary 1,

wherein the processor is configured to select a plurality of product candidates on a basis of the product information, generate, for each of the plurality of product candidates, a corresponding prompt sentence and a corresponding advertising asset sentence, evaluate the plurality of advertising asset sentences on a basis of the behavior history information, and select at least one advertising asset sentence from among the plurality of advertising asset sentences and distribute the at least one advertising asset sentence to the terminal device.

### Example 2

### (Supplementary 1)

A system comprising a processor,

wherein the processor is configured to

receive target information and user information as input data,

generate instruction information for constructing a prompt sentence as an instruction text that directs a generative AI model to generate advertising character information on the basis of the target information and the user information,

transmit the prompt sentence and the target information and the user information to the generative AI model as an external processing apparatus or an internal processing mechanism, and cause the generative AI model to automatically generate the advertising character information, evaluate the automatically generated advertising character information with respect to length, expression content, and presence or absence of prohibited expressions, process the advertising character information according to a result of the evaluation, and, when necessary, modify the prompt sentence and execute the automatic generation by the generative AI model again, insert the automatically generated or processed advertising character information into advertising configuration information to constitute advertising information, and transmit the advertising information to an advertising distribution management apparatus,

cause advertising including the advertising character information to be displayed on a terminal by outputting the advertising information distributed from the advertising distribution management apparatus to the terminal,

acquire evaluation information and correction request information input by a user via the terminal, and store the evaluation information and the correction request information as record information in association with the target information and the user information, and

generate control information for improving performance of advertising character information to be generated later by updating configuration rules of the prompt sentence or control conditions for the generative AI model on the basis of the record information.

### (Supplementary 2)

The system according to supplementary 1,

wherein the processor is configured to acquire behavior information of the user as the record information, and to optimize the advertising character information by changing configuration content of the prompt sentence or output conditions of the generative AI model on the basis of a correspondence relationship between the behavior information and the advertising character information.

### (Supplementary 3)

The system according to supplementary 1,

wherein the processor is configured to receive user attribute information and user behavior information transmitted from the terminal, dynamically reconstruct the prompt sentence according to the user attribute information and the user behavior information, regenerate the advertising character information by using the generative AI model, update the advertising information in real time, and redistribute the updated advertising information to the terminal.

### Application Example 2

### (Supplementary 1)

A system comprising a processor,

wherein the processor is configured to

acquire merchandise characteristic information and user attribute information,

analyze user behavior information and user emotion information in addition to the merchandise characteristic information and the user attribute information to generate user state information, generate a prompt sentence to be input to a generative information processing model on the basis of the merchandise characteristic information, the user attribute information, and the user state information,

cause the generative information processing model to automatically generate asset text, which is advertisement text information, by inputting the prompt sentence to the generative information processing model,

generate advertisement content information by inserting the asset text into advertisement template information,

transmit the advertisement content information to an output apparatus and cause the advertisement content information to be displayed, and

collect display information and operation information relating to the advertisement content information and update generation rules of the prompt sentence used for generation of the asset text.

### (Supplementary 2)

The system according to supplementary 1,

wherein the processor is configured to

regenerate the user state information when a change in the user behavior information and the user emotion information is detected, regenerate the prompt sentence on the basis of the regenerated user state information, regenerate the asset text by the generative information processing model, and update the advertisement content information in real time.

### (Supplementary 3)

The system according to supplementary 1,

wherein the processor is configured to

analyze performance evaluation information based on the display information and the operation information, extract a pattern of the prompt sentence or the asset text whose performance evaluation information is favorable, and automatically change the generation rules of the prompt sentence thereafter on the basis of the extracted pattern.

What is claimed is:

1. A system comprising:
circuitry configured to
receive, via a packet-switched network, a first data set relating to an item and a second data set relating to an entity,
preprocess the received first data set and second data set to generate normalized structured data,
generate a prompt data sequence based on the normalized structured data using a template,
transmit the generated prompt data sequence to a generative neural network model and acquire, from the generative neural network model, generated text output data corresponding to the prompt data sequence,
validate the generated text output data against a plurality of constraint parameters, and
associate the validated text output data with configuration data and transmit, via the packet-switched network, presentation data comprising the validated text output data to a remote device for display.

2. The system according to claim 1, wherein the circuitry is further configured to, in response to the generated text output data not satisfying at least one of the plurality of constraint parameters, perform at least one of re-requesting generation from the generative neural network model with a modified prompt data sequence and executing a correction process on the generated text output data.

3. The system according to claim 2, wherein the plurality of constraint parameters comprise a length constraint specifying a maximum character count, an expression constraint specifying permitted vocabulary patterns, and a prohibited-term constraint specifying terms to be excluded from the generated text output data.

4. The system according to claim 3, wherein the first data set comprises item attribute data including at least a category identifier, a price value, and a target segment identifier, and wherein the second data set comprises entity profile data including at least demographic information, preference information, and interaction history data.

5. The system according to claim 4, wherein the circuitry is further configured to generate the prompt data sequence by assembling an instruction portion that directs the generative neural network model to generate a text segment describing a relationship between the item attribute data and the entity profile data, the instruction portion further specifying an output format and a target length for the generated text output data.

6. The system according to claim 5, wherein the generative neural network model comprises a transformer-based language model comprising a plurality of self-attention layers, and wherein the circuitry is further configured to transmit the prompt data sequence together with model inference parameters comprising at least a temperature parameter and a maximum token count to the generative neural network model.

7. The system according to claim 6, wherein the generated text output data comprises an advertising asset sentence for use in a responsive advertisement, and wherein the configuration data comprises advertisement configuration information including at least item identification information and display control information for distribution of the responsive advertisement to the remote device.

8. The system according to claim 1, wherein the circuitry is further configured to aggregate historical interaction data associated with the entity from a storage device, generate feature data by summarizing the historical interaction data, and incorporate the feature data into the prompt data sequence to optimize the generated text output data based on the historical interaction data.

9. The system according to claim 8, wherein the historical interaction data comprises at least a content presentation history, a content selection history, and a transaction history associated with previously transmitted presentation data.

10. The system according to claim 9, wherein the circuitry is further configured to store the historical interaction data as learning data and to update at least one of a processing condition for generating the prompt data sequence and a configuration parameter of the generative neural network model based on the stored learning data.

11. The system according to claim 10, wherein the circuitry is further configured to compute a performance metric for the generated text output data based on a ratio of content selections to content presentations derived from the historical interaction data, and to adjust the prompt data sequence or the model inference parameters to increase the performance metric.

12. The system according to claim 1, wherein the circuitry is further configured to sequentially receive updated entity data and updated interaction data from the remote device via the packet-switched network, regenerate the prompt data sequence and the generated text output data based on the updated entity data and the updated interaction data, and update the configuration data in real time.

13. The system according to claim 12, wherein the circuitry is further configured to detect a change in at least one of an entity attribute value and an interaction pattern from the updated entity data and the updated interaction data, and to trigger regeneration of the prompt data sequence in response to the detected change exceeding a predetermined threshold.

14. The system according to claim 13, wherein the real-time updating comprises replacing the validated text output data in the configuration data with newly generated text output data while maintaining association with existing item identification information, and transmitting the updated presentation data to the remote device within a predetermined latency period.

15. The system according to claim 1, wherein the preprocessing comprises complementing missing values in the first data set and the second data set, normalizing numerical values to a predetermined scale, and encoding categorical values into numerical representations.

16. The system according to claim 15, wherein the circuitry is further configured to generate a plurality of prompt data sequences corresponding to a plurality of different items or a plurality of different entities, to acquire a plurality of generated text output data segments from the generative neural network model in response to the plurality of prompt data sequences, and to perform batch validation of the plurality of generated text output data segments against the plurality of constraint parameters.

17. The system according to claim 16, wherein the circuitry is further configured to acquire evaluation data and correction request data from the remote device via the packet-switched network, to store the evaluation data and the correction request data as record information in association with the first data set and the second data set, and to generate control information for updating configuration rules of the prompt data sequence or control conditions for the generative neural network model based on the record information.

18. A system comprising:
circuitry configured to
receive, via a packet-switched network, a first data set relating to an item and a second data set relating to an entity, and preprocess the received first data set and second data set comprising complementing missing values, normalizing numerical values, and encoding categorical values,
generate a prompt data sequence based on the preprocessed first data set and second data set using a template, the prompt data sequence comprising an instruction portion specifying an output format and a target length,
transmit the generated prompt data sequence to a generative neural network model comprising a transformer-based architecture and acquire generated text output data corresponding to the prompt data sequence,
validate the generated text output data against a plurality of constraint parameters comprising a length constraint, an expression constraint, and a prohibited-term constraint, and in response to the generated text output data not satisfying at least one constraint, perform re-generation or correction,
associate the validated text output data with configuration data comprising item identification information and display control information, and
transmit, via the packet-switched network, presentation data comprising the validated text output data and the display control information to a remote device for real-time display.

19. The system according to claim 18, wherein the circuitry is further configured to aggregate historical interaction data associated with the entity from a storage device, incorporate feature data derived from the historical interaction data into the prompt data sequence, and update the generated text output data and the configuration data in real time in response to receiving updated entity data or updated interaction data from the remote device.

20. A method performed by a system comprising circuitry, the method comprising:
receiving, via a packet-switched network, a first data set relating to an item and a second data set relating to an entity;
preprocessing the received first data set and second data set to generate normalized structured data;
generating a prompt data sequence based on the normalized structured data using a template;
transmitting the generated prompt data sequence to a generative neural network model and acquiring generated text output data corresponding to the prompt data sequence;
validating the generated text output data against a plurality of constraint parameters; and
associating the validated text output data with configuration data and transmitting, via the packet-switched network, presentation data comprising the validated text output data to a remote device for display.
